(19) United States
(12) Patent Application Publication
(10) Pub. No.: US 2025/0029468 A1
(43) Pub. Date: Jan. 23, 2025

(54) VEHICLE-CARRIED HAZARDOUS CHEMICAL SAFETY MONITORING SYSTEM

(71) Applicant: THE THIRD RESEARCH INSTITUTE OF MINISTRY OF PUBLIC SECURITY, Shanghai (CN)

(72) Inventor: Caixia Liu, Shanghai (CN)

(21) Appl. No.: 18/715,435

(22) PCT Filed: Nov. 4, 2022
(86) PCT No.: PCT/CN2022/129874

§ 371 Date: May 31, 2024

(30) Foreign Application Priority Data
Jun. 7, 2022 (CN) 202210640797.6

(51) Int. Cl. G08B 21/12; B60R 25/102; B60W 50/14

(52) U.S. Cl. CPC G08B 21/12; B60R 25/102; B60W 50/14

(57) ABSTRACT

Disclosed herein is a vehicle-mounted hazardous chemicals safety monitoring system. The system includes a vehicle-mounted hazardous chemicals physical and chemical safety monitoring and early warning unit, a vehicle-mounted hazardous chemicals anti-theft/robbery monitoring and early warning unit, hazardous chemical transportation emergency rescue guidance unit, a vehicle-mounted gateway unit, an alarm prompt unit, and a remote management unit. This system automatically monitors physical and chemical safety information and anti-theft/robbery safety information of vehicle-mounted hazardous chemicals, and may issue an on-site voice prompt for emergency disposal or file push guidance for a vehicle driver through the hazardous chemical transportation emergency rescue guidance unit when a vehicle triggers a vehicle-mounted hazardous chemicals physical and chemical safety monitoring and early warning and a vehicle-mounted hazardous chemicals anti-theft/robbery monitoring and early warning.

### CROSS-REFERENCE TO RELATED APPLICATIONS

The present application is a National Stage application of PCT international application: PCT/CN2022/129874, filed on 4 Nov. 2022, the disclosure of which is hereby incorporated by reference in its entirety.

### TECHNICAL FIELD

The present invention relates to a vehicle safety technology, and specifically to explosion risk control of hazardous chemicals carried on a hazardous goods transport vehicle and an anti-theft/robbery safety prevention and control technology of an automobile and vehicle-mounted hazardous chemicals.

### BACKGROUND

A transport vehicle carrying hazardous chemicals is a major source of danger, and is more likely to be involved in accidents compared with an ordinary vehicle. In addition, different from general traffic accidents, a hazardous chemical transport safety accident is often sudden, complex, and more harmful, and may even lead to serious consequences such as combustion, explosion, and leakage, resulting in a series of social problems such as economic losses, environmental pollution, ecological damage, and casualties.

It may be learnt from this that it is particularly important to do a good job in preventing theft of a hazardous chemical transport vehicle and vehicle-mounted hazardous chemicals, and in equipping more effective security equipment for on-site disposal; and perform safety monitoring on the transport vehicle carrying the hazardous chemicals, to ensure safety of the transport vehicle carrying the hazardous chemicals.

The existing safety monitoring for the transport vehicle carrying the hazardous chemicals mainly focuses on monitoring of a vehicle operation state, such as a vehicle speed, positioning, or the like; but effective monitoring on various states of the vehicle-mounted hazardous chemicals cannot be implemented.

Therefore, how to perform effective safety monitoring on the vehicle-mounted hazardous chemicals in a transportation process, thereby ensuring transport safety of the transport vehicle carrying the hazardous chemicals is an urgent problem to be resolved in the field.

### SUMMARY

For the existing problems in safety supervision in a process of carrying hazardous chemicals, a safety monitoring scheme for vehicle-mounted hazardous chemicals that can prevent and control an explosion risk of hazardous chemicals carried on a hazardous goods transport vehicle and prevent and control theft/robbery of a vehicle and vehicle-mounted hazardous chemicals is needed.

Accordingly, an objective of the present invention is to provide a vehicle-mounted hazardous chemicals safety monitoring system that comprehensively monitors a physical and chemical safety parameter of vehicle-mounted hazardous chemicals and anti-theft/robbery monitoring information of vehicle-mounted hazardous chemicals. This system can comprehensively monitor the physical and chemical safety parameter of vehicle-mounted hazardous chemicals and the anti-theft/robbery monitoring information of vehicle-mounted hazardous chemicals in a transportation process, so as to effectively improve safety of transportation of hazardous chemicals.

To achieve the foregoing object, the vehicle-mounted hazardous chemicals safety monitoring system provided in the present invention includes:
a vehicle-mounted/carried hazardous chemicals physical and chemical safety monitoring and early warning unit, where the vehicle-mounted hazardous chemicals physical and chemical safety monitoring and early warning unit is associated with a vehicle-mounted gateway unit, and is associated with an alarm prompt unit and a remote management unit through a vehicle-mounted gateway; and the vehicle-mounted hazardous chemicals physical and chemical safety monitoring and early warning unit is capable of performing real-time monitoring on a physical and chemical safety parameter of vehicle-mounted hazardous chemicals, is capable of directly cooperating with the vehicle-mounted gateway unit according to monitored information to perform early warning analysis on physical and chemical safety of the vehicle-mounted hazardous chemicals, and is capable of generating early warning information when a physical and chemical safety risk occurs on the vehicle-mounted hazardous chemicals, sending the early warning information to the remote management unit through the vehicle-mounted gateway unit, and simultaneously issuing a warning through the alarm prompt unit;
a vehicle-mounted hazardous chemicals anti-theft/robbery monitoring and early warning unit, wherein the vehicle-mounted hazardous chemicals anti-theft/robbery monitoring and early warning unit is associated with the vehicle-mounted gateway unit, and is associated with the alarm prompt unit and the remote management unit through the vehicle-mounted gateway unit; and the vehicle-mounted hazardous chemicals anti-theft/robbery monitoring and early warning unit is capable of performing real-time monitoring on anti-theft/robbery safety information of the vehicle-mounted hazardous chemicals, is capable of directly cooperating with the vehicle-mounted gateway unit according to monitored information to perform early warning analysis on a risk of being theft/robbed or lost on a vehicle carrying hazardous chemicals and the vehicle-mounted hazardous chemicals, and is capable of generating early warning information when the risk occurs, sending the early warning information to the remote management unit through the vehicle-mounted gateway unit, and simultaneously issuing a warning through the alarm prompt unit;
a hazardous chemical transportation emergency rescue guidance unit, where the hazardous chemical transportation emergency rescue guidance unit is set to be associated with the vehicle-mounted gateway unit, and is associated with the alarm prompt unit and the remote management unit through the vehicle-mounted gateway unit; and the hazardous chemical transportation emergency rescue guidance unit is capable of being linked with the vehicle-mounted hazardous chemicals physical and chemical safety monitoring and early warning unit and the vehicle-mounted hazardous chemicals anti-theft/robbery monitoring and early warning unit, and is capable of forming emergency disposal on-site guidance information for a vehicle driver when a vehicle triggers a vehicle-mounted hazardous chemicals physical and chemical safety monitoring and early warning and a vehicle-mounted hazardous chemicals anti-theft/robbery monitoring and early warning;
the vehicle-mounted gateway unit, wherein the vehicle-mounted gateway unit is separately associated with the vehicle-mounted hazardous chemicals physical and chemical safety monitoring and early warning unit, the vehicle-mounted hazardous chemicals anti-theft/robbery monitoring and early warning unit, and/or the hazardous chemical transportation emergency rescue guidance unit, the alarm prompt unit, and the remote management unit, and establishes a communication channel between each unit, to complete data exchange; and the vehicle-mounted gateway unit is capable of cooperating with the vehicle-mounted hazardous chemicals physical and chemical safety monitoring and early warning unit and/or the vehicle-mounted hazardous chemicals anti-theft/robbery monitoring and early warning unit to complete risk early warning processing according to data information collected by a corresponding unit;
the alarm prompt unit, wherein the alarm prompt unit is connected to the vehicle-mounted gateway unit, and is capable of completing a local alarm on an automobile and/or completing a remote alarm through the remote management unit associated with the vehicle-mounted gateway unit; and
the remote management unit, wherein the remote management unit is associated with the vehicle-mounted gateway unit, and is indirectly associated with the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit through the vehicle-mounted gateway unit; the remote management unit is capable of forming system configuration information and/or emergency handling information; and is further capable of receiving vehicle-mounted hazardous chemicals physical and chemical safety monitoring information and vehicle-mounted hazardous chemicals anti-theft/robbery monitoring and early warning information that are sent by the vehicle-mounted gateway unit.

Further, the vehicle-mounted hazardous chemicals physical and chemical safety monitoring and early warning unit includes:
a temperature monitoring module, a humidity monitoring module, a pressure monitoring module, a vibration monitoring module, and a leakage monitoring module.

The temperature monitoring module is configured to obtain real-time information of temperature of the vehicle-mounted hazardous chemicals, temperature in a compartment, or temperature of a tank, and transmit the obtained information to a data storage module and an edge computing module of the vehicle-mounted gateway unit or to the remote management unit through a network communication module of the vehicle-mounted gateway unit;
the humidity monitoring module is configured to obtain real-time information of humidity of the vehicle-mounted hazardous chemicals and humidity in the compartment, and transmit the obtained information to the data storage module and the edge computing module of the vehicle-mounted gateway unit or to the remote management unit through the network communication module of the vehicle-mounted gateway unit;
the pressure monitoring module is configured to obtain real-time information of pressure of the vehicle-mounted hazardous chemicals and pressure in the compartment or in the tank, and transmit the obtained information to the data storage module and the edge computing module of the vehicle-mounted gateway unit or to the remote management unit through the network communication module of the vehicle-mounted gateway unit;
the vibration monitoring module is configured to obtain real-time information of vibration in the compartment or in the tank in the vehicle carrying the vehicle-mounted hazardous chemicals, and transmit the obtained information to the data storage module and the edge computing module of the vehicle-mounted gateway unit or to the remote management unit through the network communication module of the vehicle-mounted gateway unit; and
the leakage monitoring module is configured to obtain real-time information of leakage of the vehicle-mounted hazardous chemicals and leakage of gas in the compartment in the vehicle carrying the vehicle-mounted hazardous chemicals or leakage of liquid or gas at an outlet of the tank, and transmit the obtained information to the data storage module and the edge computing module of the vehicle-mounted gateway unit or to the remote management unit through the network communication module of the vehicle-mounted gateway unit.

Further, the vehicle-mounted hazardous chemicals physical and chemical safety monitoring and early warning unit is directly associated with the vehicle-mounted gateway unit, and is indirectly associated with a vehicle alarm prompt unit and the remote management unit through the vehicle-mounted gateway unit. Various monitoring apparatuses of the temperature monitoring module, the humidity monitoring module, the pressure monitoring module, the vibration monitoring module, and the leakage monitoring module of the vehicle-mounted hazardous chemicals physical and chemical safety monitoring and early warning unit send monitoring information to the network communication module of the vehicle-mounted gateway, aggregate monitoring data to a data storage module of the vehicle-mounted gateway, and perform intelligent analysis through the edge computing module of the vehicle-mounted gateway unit, and when a temperature, humidity, pressure, vibration intensity, or a leakage monitoring result is higher than a set threshold, and when risks of combustion, explosion, and leakage of hazardous chemicals occur, send a corresponding sound and light alarm or voice prompt to the alarm prompt unit through the network communication module of the vehicle-mounted gateway unit, and simultaneously upload alarm prompt information to the remote management unit through the network communication module of the vehicle-mounted gateway.

Further, the vehicle-mounted hazardous chemicals anti-theft/robbery monitoring and early warning unit includes a vehicle anti-theft alarm module, a vehicle anti-robbery monitoring module, a vehicle anti-theft/robbery positioning and tracking module, a vehicle fuel tank security monitoring module, an access control intrusion detection module, a goods anti-theft video monitoring module, and/or a hazardous chemical goods automatic inventory module.

Further, the vehicle anti-theft alarm module is configured to monitor an illegal position movement or abnormal startup of a vehicle in a parking state, and transmit monitoring information to a data storage module and an edge computing module of the vehicle-mounted gateway unit or to the remote management unit through the network communication module of the vehicle-mounted gateway unit;
further, the vehicle anti-robbery module is configured to monitor armed persons and an abnormal gathering of persons around the vehicle, and transmit monitoring information to the data storage module and the edge computing module of the vehicle-mounted gateway unit or to the remote management unit through the network communication module of the vehicle-mounted gateway unit;
further, the vehicle anti-theft/robbery positioning and tracking module is configured to perform positioning and tracking on a real-time position of the vehicle after an anti-theft/robbery alarm is triggered, and transmit tracked positioning information to the remote management unit through the network communication module of the vehicle-mounted gateway unit;
further, the vehicle fuel tank security monitoring module is configured to perform real-time video monitoring on a position of a fuel tank of a truck carrying hazardous chemicals, and transmit monitoring information to the data storage module and the edge computing module of the vehicle-mounted gateway unit or to the remote management unit through the network communication module of the vehicle-mounted gateway unit;
further, the access control intrusion detection module is configured to monitor a compartment door body of a truck carrying explosive hazardous chemical goods or an inlet/outlet pipeline/an oil discharge valve of an oil pump of a tanker, and transmit monitoring information to the data storage module and the edge computing module of the vehicle-mounted gateway unit or to the remote management unit through the network communication module of the vehicle-mounted gateway unit;
further, the goods anti-theft video monitoring module is configured to perform video monitoring on goods inside a closed van truck carrying hazardous chemicals and all openings of the tanker, and transmit monitoring information to the data storage module and the edge computing module of the vehicle-mounted gateway unit or to the remote management unit through the network communication module of the vehicle-mounted gateway unit; and
further, the hazardous chemical goods automatic inventory module is configured to perform real-time registration on a quantity change in a loading process and a quantity change in an unloading process of the hazardous chemical goods, perform regular or irregular quantity inventory on the carried explosive hazardous chemical goods, and transmit registration and inventory information to the data storage module and the edge computing module of the vehicle-mounted gateway unit or to the remote management unit through the network communication module of the vehicle-mounted gateway unit.

Further, the vehicle anti-theft alarm module of the vehicle-mounted hazardous chemicals anti-theft/robbery monitoring and early warning unit includes but is not limited to a direct contact sensor and/or a current and voltage drop sensor and/or an ultrasonic sensor and/or a microwave sensor and/or a shock sensor and/or an inclination sensor.

The direct contact sensor is configured to trigger an alarm when a door, a trunk, or a rear hatch is forced to open;
the current and voltage drop sensor is configured to monitor a change in a vehicle circuit system, and trigger an alarm when the vehicle circuit system changes;
the ultrasonic sensor is configured to monitor a change in air pressure in a vehicle cab, and triggers an alarm when a window is broken or someone enters the vehicle cab while a vehicle is in a parking state;
the microwave sensor is configured to monitor a solid object passing through light beams emitted from all entry points in the vehicle cab, and triggers the alarm when someone enters the vehicle cab while the vehicle is in the parking state;
the shock sensor is configured to monitor a sudden shock of the vehicle, and triggers the alarm when someone tries to break the glass and enter the vehicle cab or destroy the vehicle; and
the inclination sensor is configured to monitor sudden inclination of the vehicle, and triggers the alarm when someone tries to tow the vehicle away.

Further, the vehicle anti-robbery monitoring module of the vehicle-mounted hazardous chemicals anti-theft/robbery monitoring and early warning unit includes but is not limited to a video monitoring device outside a vehicle, a concealed alarm button, a wireless emission pinhole video camera, a warning light, a tear gas sprayer outside a vehicle body, and another self-defense equipment.

The video monitoring device outside a vehicle is configured to collect an image of a person around the vehicle, and triggers the alarm when a plurality of armed persons approach or an abnormal gathering of persons occurs;
the concealed alarm button is configured to issue a robbery emergency alarm when a driver has confirmed that a robbery event occurs;
the wireless emission pinhole video camera is configured to collect a behavior image of a robbery gangster outside the vehicle body when the robbery emergency alarm is triggered;
the tear gas sprayer outside a vehicle body is configured to automatically release commonly used tear gas sprays such as CS (o-chlorobenzylidene malononitrile) and/or CN (phenyl chloroacetophenone) and/or OC (capsaicin), or the like when the robbery emergency alarm is triggered, to strongly stimulate the eyes, nasal cavity, mouth, skin, and respiratory senses of the gangster at a scene of robbery;
the warning light is configured to continuously flash on the roof of the vehicle when the robbery emergency alarm is triggered, psychologically deter the gangster at the scene of the robbery, and guide a position of the vehicle for the police rushing to the scene of the robbery; and
the another self-defense equipment includes but is not limited to a strong light flashlight, a swing stick, a flash bomb, or a small dry powder fire extinguisher, and is configured to delay robbery by the driver and the passenger when the emergency alarm is triggered, to improve a sense of safety and self-defense capabilities of the driver and the passenger.

Further, the vehicle anti-theft/robbery positioning and tracking module of the vehicle-mounted hazardous chemicals anti-theft/robbery monitoring and early warning unit includes but is not limited to a deep dormancy tracking locator, a solar charger, and a pinhole infrared camera at a driver's position of a vehicle.

The deep dormancy tracking locator is configured to start real-time positioning after the vehicle is theft/robbed and a satellite positioning system of a vehicle-mounted terminal unit is destroyed or powered off. The tracking locator includes but is not limited to Beidou satellite positioning and/or GPS positioning and/or GLONASS positioning and/or GSNS satellite positioning;
the solar charger is configured to charge the deep dormancy tracking locator, to ensure that the deep dormancy tracking locator is in an operating state after being started; and
the pinhole infrared camera at a driver's position of a vehicle is configured to collect, in real time, an image of a person at the driver's position of the vehicle after the deep dormancy tracking locator is started.

Further, the vehicle fuel tank security monitoring module of the vehicle-mounted hazardous chemicals anti-theft/robbery monitoring and early warning unit includes but is not limited to an infrared detector disposed on a fuel tank cap, a vibration sensor, a liquid level sensor disposed in a fuel tank and/or a pinhole infrared camera that is capable of monitoring a position of a fuel tank in real time.

The infrared detector is configured to detect a person approaching a fuel tank in an armed state in which the fuel tank does not need to be refueled, and triggers an alarm when a person enters a detection area in the armed state; the infrared detector includes a passive infrared detector or an active infrared detector;
the vibration sensor is configured to detect abnormal vibration of a fuel tank cap in the armed state in which the fuel tank does not need to be refueled, and triggers an alarm when the fuel tank cap vibrates in the armed state;
a liquid level sensor in the fuel tank is configured to detect an abnormal drop of a gasoline or diesel liquid level in the fuel tank, and triggers an alarm when the oil level drops rapidly in the armed state; and
the pinhole infrared camera that is capable of monitoring a position of the fuel tank is configured to collect an image of a person approaching the fuel tank in the armed state in which the fuel tank does not need to be refueled, and starts the camera when a vehicle fuel tank security monitoring alarm is triggered.

Further, the access control intrusion detection module of the vehicle-mounted hazardous chemicals anti-theft/robbery monitoring and early warning unit includes but is not limited to an access controller disposed on a compartment door of a truck carrying hazardous chemical goods or an inlet/outlet pipeline/an oil discharge valve of an oil pump of a tanker, a passive infrared intrusion detector and/or an active infrared intrusion detector and/or a microwave intrusion detector and/or a radar microwave detector and/or a switchable detector and/or an ultrasonic detector and/or a sound-activated detector and/or a wireless magnetic switch detector, a vibration sensor, and a pinhole camera that is capable of monitoring a position of a compartment door of a truck or an inlet/outlet pipeline/an oil discharge valve of an oil pump of a tanker in real time.

The access controller is configured to control opening and closing of the compartment door of the truck carrying hazardous chemical goods or the inlet/outlet pipeline/the oil discharge valve of the oil pump of the tanker, and triggers an alarm when abnormal opening occurs;
the passive infrared intrusion detector and/or the active infrared intrusion detector and/or the microwave intrusion detector and/or the radar microwave detector and/or the switchable detector and/or the ultrasonic detector and/or the sound-activated detector and/or the wireless magnetic switch detector is configured to detect abnormal approaching of a person or abnormal opening of the compartment door, the inlet/outlet pipeline/the oil discharge valve in the armed state, and an alarm is triggered when abnormal approaching of a person or abnormal opening of the compartment door, the inlet/outlet pipeline/the oil discharge valve in the armed state occurs;
the vibration sensor is configured to trigger an alarm when abnormal vibration of the compartment door, the inlet/outlet pipeline/the oil discharge valve in the armed state occurs, and when the compartment door, the inlet/outlet pipeline/the oil discharge valve vibrates in the armed state; and
the pinhole camera at the position of the compartment door of the truck or the inlet/outlet pipeline/the oil discharge valve of the oil pump of the tanker is configured to collect an image of a person approaching the compartment door, the inlet/outlet pipeline/the oil discharge valve in the armed state, and start the camera when the access control intrusion monitoring alarm is triggered.

Further, the goods anti-theft video monitoring module of the vehicle-mounted hazardous chemicals anti-theft/robbery monitoring and early warning unit includes goods image monitoring cameras disposed above four corners of a compartment and a process monitoring camera that directly faces a compartment door and that is disposed in the compartment.

The goods image monitoring camera is disposed above four corners of the compartment, and is configured to collect a real-time image of the hazardous chemical goods after being carried; and
the process monitoring camera is disposed at a position in the compartment that directly faces the compartment door, and is configured to collect images of a loading process and an unloading process.

Further, the hazardous chemical goods automatic inventory module of the vehicle-mounted hazardous chemicals anti-theft/robbery monitoring and early warning unit includes a code scanner or a radio frequency identification (RFID) card reader disposed at the compartment door, a barcode label, a two-dimensional code label, or a radio frequency identification (RFID) electronic label installed or pasted on the packaging of the hazardous chemical goods.

The code scanner or the radio frequency identification (RFID) card reader is configured to read the barcode label, the two-dimensional code label, or the radio frequency identification (RFID) electronic label on the packaging of the hazardous chemical goods.

The barcode label, the two-dimensional code label, or the radio frequency identification (RFID) electronic label is configured to be pasted on the packaging of the hazardous chemical goods, to perform reading statistics in a process of loading and unloading.

A combined configuration of the radio frequency identification (RFID) card reader and the radio frequency identification (RFID) electronic label may be further configured to perform periodic or irregular inventory in a process of transportation.

Further, the vehicle-mounted hazardous chemicals anti-theft/robbery monitoring and early warning unit is directly associated with the vehicle-mounted gateway unit, and is indirectly associated with a vehicle alarm prompt unit and a remote management unit through the vehicle-mounted gateway unit. Various monitoring apparatuses, detection apparatuses, and cameras of a vehicle anti-theft alarm module, a vehicle anti-robbery monitoring module, a vehicle anti-theft/robbery positioning and tracking module, a vehicle fuel tank security monitoring module, an access control intrusion detection module, a goods anti-theft video monitoring module, and/or a hazardous chemical goods automatic inventory module of the vehicle-mounted hazardous chemicals anti-theft/robbery monitoring and early warning unit aggregate monitoring data to the data storage module of the vehicle-mounted gateway through the network communication module of the vehicle-mounted gateway, and perform intelligent analysis through the edge computing module of the vehicle-mounted gateway unit, and when a corresponding anti-theft/robbery warning is triggered, send a corresponding sound and light alarm or voice prompt to the alarm prompt unit through the network communication module of the vehicle-mounted gateway unit, and simultaneously upload the alarm prompt information to the remote management unit through the network communication module of the vehicle-mounted gateway.

Further, the hazardous chemical transportation emergency rescue guidance unit includes an emergency rescue guidance information module, a voice broadcast module, and an automatic push module.

The emergency rescue guidance information module is configured to provide guidance information such as emergency rescue knowledge of hazardous chemicals, and may be set in the data storage module of the vehicle-mounted gateway unit or the remote management unit;
the voice broadcast module is configured to perform voice broadcast on emergency rescue guidance information in real time when an early warning and an alarm occur, to guide a driver and a passenger to perform preliminary emergency disposal, and may be set separately or share the voice prompt module of the alarm prompt unit; and
the automatic push module is configured to push an emergency rescue guidance information file in real time when the early warning and the alarm occur, to guide the driver and the passenger to perform preliminary emergency disposal, and a push display apparatus may be disposed separately or use driver and passenger client software.

Further, the hazardous chemical transportation emergency rescue guidance unit is directly associated with the vehicle-mounted gateway unit, and is indirectly associated with a vehicle alarm prompt unit and the remote management unit through the vehicle-mounted gateway unit. The hazardous chemical transportation emergency rescue guidance unit transmits the emergency rescue guidance information through the network communication module of the vehicle-mounted gateway, transmits the emergency rescue guidance information through a module of the vehicle-mounted gateway, stores the emergency rescue guidance information through the data storage of the vehicle-mounted gateway unit or the remote management unit, performs voice broadcast of the emergency rescue guidance information through the voice broadcast module disposed separately or the voice prompt module of the shared alarm prompt unit, and simultaneously displays the pushed emergency rescue guidance information file through an separately disposed display apparatus or driver and passenger client software.

Further, the vehicle-mounted gateway unit includes: a network communication module and/or a data storage module and/or an edge computing module.

The network communication module is configured to perform data exchange between the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit and the remote management unit, forward the monitoring information uploaded by the vehicle-mounted hazardous chemicals physical and chemical safety monitoring and early warning unit and the vehicle-mounted hazardous chemicals anti-theft/robbery monitoring and early warning unit and the analysis result to the remote management unit, or forward the alarm instruction and the voice prompt instruction information to the alarm prompt unit according to the received remote management unit instruction, and forward instruction information such as alarm threshold setting adjustment and circuit control to the related monitoring apparatuses of the vehicle-mounted hazardous chemicals physical and chemical safety monitoring and early warning unit and the vehicle-mounted hazardous chemicals anti-theft/robbery monitoring and early warning unit;
the data storage module is configured to store monitoring information uploaded by the vehicle-mounted hazardous chemicals physical and chemical safety monitoring and early warning unit and the vehicle-mounted hazardous chemicals anti-theft/robbery monitoring and early warning unit and an emergency rescue guidance information file of the hazardous chemical transportation emergency rescue guidance unit; and
the edge computing module is configured to perform intelligent analysis and determining on the monitoring information uploaded by the vehicle-mounted hazardous chemicals physical and chemical safety monitoring and early warning unit and the vehicle-mounted hazardous chemicals anti-theft/robbery monitoring and early warning unit.

Further, the vehicle-mounted gateway unit is directly associated with the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, the alarm prompt unit, and the remote management unit. When the vehicle-mounted gateway unit receives the monitoring information from the vehicle-mounted hazardous chemicals physical and chemical safety monitoring and early warning unit and the vehicle-mounted hazardous chemicals anti-theft/robbery monitoring and early warning unit, and analyzes and determines that hazardous chemicals explosion or theft/robbery-related early warning and alarm is triggered, a sound and light alarm or voice prompt information is sent to the alarm prompt unit through the vehicle-mounted gateway unit and early warning and alarm information and real-time monitoring information are sent to the remote management unit; and when receiving an alarm instruction, a voice prompt instruction, alarm threshold setting adjustment or emergency rescue guidance information sent by the remote management unit, the vehicle-mounted gateway sends the alarm instruction and the voice prompt instruction information to the alarm prompt unit, sends the alarm threshold setting adjustment and circuit control instruction information to related monitoring apparatuses of the vehicle-mounted hazardous chemicals physical and chemical safety monitoring and early warning unit and the vehicle-mounted hazardous chemicals anti-theft/robbery monitoring and early warning unit to adjust an alarm threshold of a monitoring sensor and start a positioning and tracking apparatus or a related operation of a related pinhole camera, and sends emergency rescue guidance voice broadcast information to a voice broadcast module of the hazardous chemical transportation emergency rescue guidance unit to guide the driver and the passenger to perform preliminary emergency disposal.

Further, the alarm prompt unit includes vehicle local alarm prompt subunits such as a sound and light alarm in a cab module, a voice prompt in a cab module, a sound and light alarm outside a cab module, a voice prompt outside a cab module, and the like, and remote monitoring client software alarm prompt subunits such as government industry management client software, enterprise operation management client software, driver and passenger service client software, and the like.

Further, the alarm prompt unit is directly associated with the vehicle-mounted gateway unit, and is indirectly associated with the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the remote management unit through the vehicle-mounted gateway unit. When the local alarm prompt subunit receives vehicle-mounted hazardous chemicals physical and chemical safety monitoring and early warning information or vehicle-mounted hazardous chemicals anti-theft/robbery monitoring and early warning information of a medium risk level or a low risk level sent by the vehicle-mounted gateway, the alarm prompt unit issues a sound and light alarm in a cab and voice prompts the driver to stop nearby or stop immediately for inspection; when the local alarm prompt subunit receives vehicle-mounted hazardous chemicals physical and chemical safety monitoring and early warning information or vehicle-mounted hazardous chemicals anti-theft/robbery monitoring and early warning information of a high risk level, the alarm prompt unit issues a sound and light alarm inside and outside a cab and voice prompts the driver to stop immediately for inspection, prompt a passer-by to be alert to anomaly of the vehicle, avoid in time, or call the police immediately, or warn a gangster who is in a theft/robbery state to stop crimes; when a remote monitoring client software alarm prompt subunit receives the vehicle-mounted hazardous chemicals physical and chemical safety monitoring and early warning information or the vehicle-mounted hazardous chemicals anti-theft/robbery monitoring and early warning information of a medium risk level or a low risk level, the alarm prompt unit issues an alarm prompt; and when the remote monitoring client software alarm prompt subunit receives the vehicle-mounted hazardous chemicals physical and chemical safety monitoring and early warning information or the vehicle-mounted hazardous chemicals anti-theft/robbery monitoring and early warning information of a high risk level, the alarm prompt unit issues an emergency alarm and a voice prompt, sends the emergency rescue guidance information, and starts an emergency management procedure by default according to an emergency scheme.

Further, the remote management unit includes:
government industry management client software, enterprise operation management client software, driver and passenger service client software, and a communication center.
the government industry management client software is configured to receive and display vehicle-mounted hazardous chemicals physical and chemical safety monitoring and early warning information or vehicle-mounted hazardous chemicals anti-theft/robbery monitoring and early warning information of a high risk level forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, issue a related management instruction according to the received early warning and alarm information, start an emergency management procedure, and issue a related emergency disposal instruction;
the enterprise operation management client software is configured to receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, and issue the related management instruction or emergency rescue guidance information according to the received early warning and alarm information; when receiving the vehicle-mounted hazardous chemicals physical and chemical safety monitoring and early warning information or the vehicle-mounted hazardous chemicals anti-theft/robbery monitoring and early warning information of a high risk level, start the emergency management procedure, push vehicle-mounted hazardous chemical emergency rescue guidance file information to a vehicle-mounted hazardous chemicals emergency rescue guidance module, send an emergency alarm to a government industry management client, and issue the related emergency disposal instruction;
the driver and passenger service client software is configured to receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, issue a sound and light alarm, a voice prompt, and emergency rescue guidance corresponding to alarm and early warning information according to the received alarm and early warning information, prompt a driver to stop nearby or immediately stop for inspection, and provide a corresponding emergency disposal guidance scheme; and
the communication center is configured to communicate with the vehicle-mounted gateway unit, receive and store the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit, and separately forward to the government industry management client software, the enterprise operation management client software, and the driver and passenger service client software. The communication center also serves as a computer system environment for the government industry management client software, the enterprise operation management client software, and the driver and passenger service client software, to support related software applications, and forwards management instructions or response instructions of the government industry management client software, the enterprise operation management client software, and the driver and passenger service client software to the vehicle-mounted gateway unit.

Further, the remote management unit is set on a cloud platform of a government industry competent department related to vehicle traffic management or operation management and/or a local storage server and/or personal handheld intelligent terminals of related management personnel, and a cloud platform of a transportation enterprise to which a vehicle belongs and a related transportation party and/or a local storage server and/or personal handheld intelligent terminals of related management personnel and personal handheld intelligent terminals of a driver and a passenger, is associated with the vehicle-mounted gateway unit, and is indirectly associated with the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit through the vehicle-mounted gateway unit. The remote management unit receives the vehicle-mounted hazardous chemicals physical and chemical safety monitoring and early warning information or the vehicle-mounted hazardous chemicals anti-theft/robbery monitoring and early warning information that are sent by the vehicle-mounted gateway unit, issues a driver management operation instruction according to the alarm information, feeds back the driver management operation instruction to the vehicle-mounted gateway unit, and feeds back the driver management operation instruction to the alarm prompt unit through the vehicle-mounted gateway; and the remote management unit supports setting and adjustment of an early warning and alarm threshold and an information upload frequency of related monitoring devices of the vehicle-mounted hazardous chemicals physical and chemical safety monitoring and early warning unit and the vehicle-mounted hazardous chemicals anti-theft/robbery monitoring and early warning unit through related monitoring client software, and pushes emergency rescue guidance information of hazardous chemical transportation.

The vehicle-mounted hazardous chemicals safety monitoring system provided in the present invention may perform comprehensive real-time monitoring on temperature of vehicle-mounted hazardous chemicals and temperature in a compartment, humidity of the vehicle-mounted hazardous chemicals and humidity in the compartment, pressure of the vehicle-mounted hazardous chemicals and pressure in the compartment or in a tank, vibration in the compartment in the vehicle carrying the vehicle-mounted hazardous chemicals or the tank, leakage of the vehicle-mounted hazardous chemicals and leakage of gas in the compartment in the vehicle carrying the vehicle-mounted hazardous chemicals, or leakage of liquid or gas of an outlet of the tank, to comprehensively determine whether there are risks of combustion, explosion, and leakage of the hazardous chemicals. When the temperature, the humidity, the pressure, the vibration intensity, or a leakage monitoring result are higher than a set threshold, and there may be risks of combustion, explosion, and leakage of the hazardous chemicals, early warning information is issued, and an early warning is triggered. The early warning information is sent to the remote management unit through the network communication module of the vehicle-mounted gateway, and local early warning sound and light is simultaneously issued through the alarm prompt unit, or the driver is voice prompted to stop for inspection.

The vehicle-mounted hazardous chemicals safety monitoring system provided in the present invention may further monitor an illegal position movement or abnormal startup when the vehicle is in a parking state, armed persons and an abnormal gathering of persons around the vehicle, perform positioning and tracking on a real-time position of the vehicle after an anti-theft/robbery alarm is triggered, perform real-time video monitoring on a position of the fuel tank in the truck carrying the hazardous chemicals, goods inside a closed van truck carrying the hazardous chemicals, and all openings of the tanker, perform real-time registration on a quantity change in a loading process and a quantity change in an unloading process of hazardous chemicals, and perform periodic or irregular quantity inventory on the carried hazardous chemicals, to comprehensively determine whether the vehicle carrying the hazardous chemicals and the vehicle-mounted hazardous chemicals are at risk of being theft/robbed or lost. When a detection result or an intelligent analysis result of a monitored object triggers a theft/robbery early warning or alarm, the early warning or alarm information is sent to the remote management unit through the network communication module of the vehicle-mounted gateway, and the corresponding local early warning sound and light is simultaneously issued through the alarm prompt unit or the driver is voice prompted to stop for inspection or prepare for defense.

### BRIEF DESCRIPTION OF THE DRAWINGS

The present invention is further described below with reference to the accompanying drawings and specific implementations.

FIG. 1 is a schematic diagram of an overall constitutional principle of a vehicle-mounted hazardous chemicals safety monitoring system in an example of the present invention;

FIG. 2 is a schematic diagram of a constitutional principle and a use process of a vehicle-mounted hazardous chemicals physical and chemical safety monitoring and early warning unit in an example of the present invention;

FIG. 3 is a schematic diagram of a constitutional principle and a use process of a vehicle-mounted hazardous chemicals anti-theft/robbery monitoring and early warning unit in an example of the present invention;

FIG. 4 is a schematic diagram of composition of a vehicle anti-theft alarm module of an anti-theft/robbery monitoring and early warning unit in an example of the present invention;

FIG. 5 is a schematic diagram of composition of a vehicle anti-robbery monitoring module of an anti-theft/robbery monitoring and early warning unit in an example of the present invention;

FIG. 6 is a schematic diagram of composition of a vehicle anti-theft/robbery positioning and tracking module of an anti-theft/robbery monitoring and early warning unit in an example of the present invention;

FIG. 7 is a schematic diagram of composition of a vehicle fuel tank security monitoring module of an anti-theft/robbery monitoring and early warning unit in an example of the present invention;

FIG. 8 is a schematic diagram of composition of an access control intrusion detection module of an anti-theft/robbery monitoring and early warning unit in an example of the present invention;

FIG. 9 is a schematic diagram of composition of a goods anti-theft video monitoring module of an anti-theft/robbery monitoring and early warning unit in an example of the present invention;

FIG. 10 is a schematic diagram of composition of a hazardous chemical goods automatic inventory module of an anti-theft/robbery monitoring and early warning unit in an example of the present invention;

FIG. 11 is a schematic diagram of a constitutional principle and a use process of hazardous chemical transportation emergency rescue guidance unit in an example of the present invention;

FIG. 12 is a schematic diagram of a constitutional principle of a vehicle-mounted gateway unit and a network communication module of the vehicle-mounted gateway unit in an example of the present invention;

FIG. 13 is a schematic diagram of a constitutional principle and a use process of an alarm prompt unit in an example of the present invention;

FIG. 14 is a schematic diagram of a constitutional principle and a use process of a remote management unit in an example of the present invention;

FIG. 15 is a schematic diagram of a constitutional principle of a government industry management client in an example of the present invention;

FIG. 16 is a schematic diagram of a constitutional principle of an enterprise operation management client in an example of the present invention;

FIG. 17 is a schematic diagram of a constitutional principle of a driver and passenger service client in an example of the present invention; and

FIG. 18 is a schematic diagram of composition of a communication center in an example of the present invention.

### DETAILED DESCRIPTION

To make technical means, creative features, goals and effects achieved by the present invention easy to understand, the present invention will be further described below with reference to specific illustrations.

An accident in transportation of hazardous chemicals is sudden, complex, and harmful, and will lead to serious consequences such as combustion, explosion, and leakage, resulting in economic losses, environmental pollution, ecological damage, casualties, and a vehicle carrying hazardous chemicals being a typical target for preventing terrorist attacks in the transportation industry, and there is a risk that the vehicle is theft/robbed, and is used for terrorist activities after being theft/robbed by criminals. It is necessary to perform comprehensive and effective safety monitoring on vehicle-mounted hazardous chemicals in a process of transportation. This example provides a vehicle-mounted hazardous chemicals safety monitoring system that can comprehensively monitor a physical and chemical safety parameter of vehicle-mounted hazardous chemicals, theft/robbery prediction images and position information of a vehicle and the vehicle-mounted hazardous chemicals.

The vehicle-mounted hazardous chemicals safety monitoring system provided in this example, through organic integration and application of the Internet of Things, cloud computing, machine vision, and an artificial intelligence AI technology, may implement synchronous real-time monitoring on temperature of vehicle-mounted hazardous chemicals and temperature in a compartment, humidity of the vehicle-mounted hazardous chemicals and humidity in the compartment, pressure of the vehicle-mounted hazardous chemicals and pressure in the compartment or in a tank, vibration in the compartment or the tank in the vehicle carrying the vehicle-mounted hazardous chemicals, leakage of the vehicle-mounted hazardous chemicals and leakage of gas in the compartment in the vehicle carrying the vehicle-mounted hazardous chemicals, or leakage of liquid or gas of an outlet of the tank, and based on this, comprehensively determine whether risks of combustion, explosion, or leakage of the hazardous chemicals occur. When the temperature, the humidity, the pressure, the vibration intensity, or a leakage monitoring result are higher than a set threshold, and there may be risks of combustion, explosion, and leakage of the hazardous chemicals, early warning information is issued.

In addition, the vehicle-mounted hazardous chemicals safety monitoring system provided in this example may further monitor an illegal position movement or abnormal startup when the vehicle is in a parking state, and armed persons and an abnormal gathering of persons around the vehicle, perform positioning and tracking on a real-time position of the vehicle after an anti-theft/robbery alarm is triggered, perform real-time video monitoring on a position of the fuel tank in the truck carrying the hazardous chemicals, goods inside a closed van truck carrying the hazardous chemicals, and all openings of the tanker, perform real-time registration on a quantity change in a loading process and a quantity change in an unloading process of hazardous chemicals, and perform periodic or irregular quantity inventory on the carried hazardous chemicals, to comprehensively determine whether the vehicle carrying the hazardous chemicals and the vehicle-mounted hazardous chemicals are at risk of being theft/robbed or lost. When a detection result or an intelligent analysis result of a monitored object triggers a risk early warning or a theft/robbery early warning or an alarm of explosion of the vehicle-mounted hazardous chemicals, an early warning or alarm information is sent to a remote management unit through a network communication module of a vehicle-mounted gateway, and corresponding local early warning sound and light is simultaneously issued or a driver is voice prompted to stop for inspection or prepare for defense through an alarm prompt unit, to prevent a major vicious traffic accident caused by explosion of the hazardous chemicals carried on the vehicle and to prevent the vehicle-mounted hazardous chemicals from being used in terrorist activities after being theft/robbed.

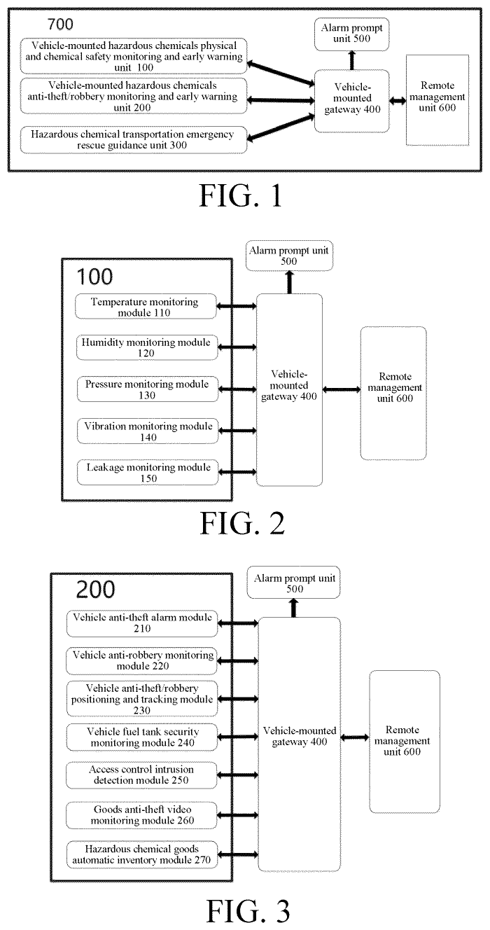

FIG. 1 is a schematic diagram of an overall constitutional principle of a vehicle-mounted hazardous chemicals safety monitoring system in this example.

As shown in FIG. 1, the vehicle-mounted hazardous chemicals safety monitoring system 700 provided in this example mainly includes a vehicle-mounted hazardous chemicals physical and chemical safety monitoring and early warning unit 100, a vehicle-mounted hazardous chemicals anti-theft/robbery monitoring and early warning unit 200, hazardous chemical transportation emergency rescue guidance unit 300, a vehicle-mounted gateway unit 400, an alarm prompt unit 500, and a remote management unit 600 that cooperate with each other.

As shown in FIG. 1, sensors of the vehicle-mounted hazardous chemicals physical and chemical safety monitoring and early warning unit 100 in this system are disposed on outer packaging and in inner packaging of vehicle-mounted hazardous chemicals, or at different positions in a compartment of a truck carrying hazardous chemicals, is associated with the vehicle-mounted gateway unit 400 of the vehicle, and is associated with the alarm prompt unit 500 and the remote management unit 600 through the vehicle-mounted gateway unit 400.

The vehicle-mounted hazardous chemicals physical and chemical safety monitoring and early warning unit 100 may perform real-time monitoring on temperature of vehicle-mounted hazardous chemicals and temperature in a compartment, humidity of the vehicle-mounted hazardous chemicals and humidity in the compartment, pressure of the vehicle-mounted hazardous chemicals and pressure in the compartment or in a tank, vibration in the compartment or the tank in the vehicle carrying the vehicle-mounted hazardous chemicals, leakage of the vehicle-mounted hazardous chemicals and leakage of gas, or leakage of liquid or gas of an outlet of the tank in the compartment in the vehicle carrying the vehicle-mounted hazardous chemicals.

Next, the vehicle-mounted hazardous chemicals physical and chemical safety monitoring and early warning unit 100 may further store the collected monitoring information in a data storage module of the vehicle-mounted gateway 400, and analyze the collected monitoring result through the sensors or through an edge computing module of the vehicle-mounted gateway 400, to comprehensively determine whether there are risks of combustion, explosion, or leakage of the hazardous chemicals. When the temperature, the humidity, the pressure, the vibration intensity, or a leakage monitoring result are higher than a set threshold, and there may be risks of combustion, explosion, and leakage of the hazardous chemicals, early warning information is issued, and an early warning is triggered. The early warning information is sent to the remote management unit 600 through the network communication module of the vehicle-mounted gateway 400, and local early warning sound and light is simultaneously issued through the alarm prompt unit, or the driver is voice prompted to stop for inspection.

FIG. 2 is a schematic diagram of a specific constitutional principle and a use process of a vehicle-mounted hazardous chemicals physical and chemical safety monitoring and early warning unit 100 in an example of the present invention.

As shown in FIG. 2, the vehicle-mounted hazardous chemicals physical and chemical safety monitoring and early warning unit 100 provided in this example mainly includes a temperature monitoring module 110, a humidity monitoring module 120, a pressure monitoring module 130, a vibration monitoring module 140, and a leakage monitoring module 150 that cooperate with other.

For the convenience of expression, a basic constitutional scheme of the vehicle-mounted gateway unit 400 in the following example scheme is described herein. FIG. 12 is a schematic diagram of a constitutional principle of a vehicle-mounted gateway unit and a network communication module of the vehicle-mounted gateway unit in an example of the present invention. As shown in FIG. 12, the vehicle-mounted gateway unit 400 of the vehicle-mounted hazardous chemicals safety monitoring system 700 provided in this example mainly includes a network communication module 410, a data storage module 420, and an edge computing module 430 that cooperate with other.

Further, the temperature monitoring module 110 of the vehicle-mounted hazardous chemicals physical and chemical safety monitoring and early warning unit 100 is configured to obtain real-time information of temperature of the vehicle-mounted hazardous chemicals, temperature in a compartment, or temperature of a tank, and transmit the obtained information to the data storage module and the edge computing module of the vehicle-mounted gateway unit or to the remote management unit through the network communication module of the vehicle-mounted gateway unit.

The humidity monitoring module 120 of the vehicle-mounted hazardous chemicals physical and chemical safety monitoring and early warning unit 100 is configured to obtain real-time information of humidity of the vehicle-mounted hazardous chemicals and humidity in the compartment, and transmit the obtained information to the data storage module and the edge computing module of the vehicle-mounted gateway unit or to the remote management unit through the network communication module of the vehicle-mounted gateway unit.

The pressure monitoring module 130 of the vehicle-mounted hazardous chemicals physical and chemical safety monitoring and early warning unit 100 is configured to obtain real-time information of pressure of the vehicle-mounted hazardous chemicals and pressure in the compartment or in the tank, and transmit the obtained information to the data storage module and the edge computing module of the vehicle-mounted gateway unit or to the remote management unit through the network communication module of the vehicle-mounted gateway unit.

The vibration monitoring module 140 of the vehicle-mounted hazardous chemicals physical and chemical safety monitoring and early warning unit 100 is configured to obtain real-time information of vibration in the compartment or in the tank in the vehicle carrying the vehicle-mounted hazardous chemicals, and transmit the obtained information to the data storage module and the edge computing module of the vehicle-mounted gateway unit or to the remote management unit through the network communication module of the vehicle-mounted gateway unit.

The leakage monitoring module 150 of the vehicle-mounted hazardous chemicals physical and chemical safety monitoring and early warning unit 100 is configured to obtain real-time information of leakage of the vehicle-mounted hazardous chemicals and leakage of gas in the compartment or leakage of liquid or gas at an outlet of the tank in the vehicle carrying the vehicle-mounted hazardous chemicals, and transmit the obtained information to the data storage module and the edge computing module of the vehicle-mounted gateway unit or to the remote management unit through the network communication module of the vehicle-mounted gateway unit.

As shown in FIG. 1, FIG. 2, and FIG. 12, the vehicle-mounted hazardous chemicals physical and chemical safety monitoring and early warning unit 100 thus set helps use the temperature monitoring module 110, and performs real-time monitoring on temperature of the vehicle-mounted hazardous chemicals and temperature in the compartment, performs real-time monitoring on humidity of the vehicle-mounted hazardous chemicals and humidity in the compartment by using the humidity monitoring module 120, performs real-time monitoring on pressure of the vehicle-mounted hazardous chemicals and pressure in the compartment or in the tank by using the pressure monitoring module 130, performs real-time monitoring on vibration in the compartment or the tank in the vehicle carrying the vehicle-mounted hazardous chemicals by using the vibration monitoring module 140, and performs real-time monitoring on leakage of the vehicle-mounted hazardous chemicals and leakage of gas in the compartment or leakage of liquid or gas of an outlet of the tank in the vehicle carrying the vehicle-mounted hazardous chemicals by using the leakage monitoring module 150.

The vehicle-mounted hazardous chemicals physical and chemical safety monitoring and early warning unit 100 uploads monitoring information to the data storage module 420 of the vehicle-mounted gateway unit 400 through the network communication module 410 of the vehicle-mounted gateway unit 400, and performs intelligent analysis through the edge computing module 430 of the vehicle-mounted gateway unit 400. When the temperature, the humidity, the pressure, the vibration intensity, or a leakage monitoring result are higher than a set threshold, and there may be risks of combustion, explosion, and leakage of the hazardous chemicals, early warning information is issued, and an early warning is triggered. The early warning information is sent to the remote management unit 600 through the network communication module 410 of the vehicle-mounted gateway unit 400, and local early warning sound and light or a voice prompt is simultaneously issued through the alarm prompt unit 500.

As shown in FIG. 1, the vehicle-mounted hazardous chemicals anti-theft/robbery monitoring and early warning unit 200 in this system is set at positions such as a vehicle cab, inside the vehicle, outside the vehicle body, inside the compartment, a door body of the compartment, an opening of a fuel tank of the vehicle, and an inlet/outlet pipeline of an oil pump/an oil discharge valve of a tanker, and the like, is associated with the vehicle-mounted gateway unit 400, and is associated with the alarm prompt unit 500 and the remote management unit 600 through the vehicle-mounted gateway 400.

The vehicle-mounted hazardous chemicals anti-theft/robbery monitoring and early warning unit 200 may monitor an illegal position movement or abnormal startup when the vehicle is in a parking state, and armed persons and an abnormal gathering of persons around the vehicle, perform positioning and tracking on a real-time position of the vehicle after an anti-theft/robbery alarm is triggered, perform real-time video monitoring on a position of the fuel tank in the truck carrying the hazardous chemicals, goods inside a closed van truck carrying the hazardous chemicals, and all openings of the tanker, perform real-time registration on a quantity change in a loading process and a quantity change in an unloading process of hazardous chemicals, and perform periodic or irregular quantity inventory on the carried hazardous chemicals.

Based on this, the vehicle-mounted hazardous chemicals anti-theft/robbery monitoring and early warning unit 200 may further store the collected monitoring and video monitoring information in the data storage module of the vehicle-mounted gateway, and perform intelligent analysis on the collected monitoring result through the apparatus or through the edge computing module of the vehicle-mounted gateway, to comprehensively determine whether the vehicle carrying the hazardous chemicals and the vehicle-mounted hazardous chemicals are at risk of being theft/robbed or lost. When a detection result or an intelligent analysis result of a monitored object triggers a theft/robbery early warning or alarm, the early warning or alarm information is sent to the remote management unit through the network communication module of the vehicle-mounted gateway, and the corresponding local early warning sound and light is simultaneously issued through the alarm prompt unit or the driver is voice prompted to stop for inspection or prepare for defense.

FIG. 3 is a schematic diagram of a specific constitutional principle and a use process of a vehicle-mounted hazardous chemicals anti-theft/robbery monitoring and early warning unit 200 of a vehicle-mounted hazardous chemicals safety monitoring system provided in this example.

As shown in FIG. 3, the vehicle-mounted hazardous chemicals anti-theft/robbery monitoring and early warning unit 200 provided in this example mainly includes a vehicle anti-theft alarm module 210, a vehicle anti-robbery monitoring module 220, a vehicle anti-theft/robbery positioning and tracking module 230, a vehicle fuel tank security monitoring module 240, an access control intrusion detection module 250, a goods anti-theft video monitoring module 260, and/or a hazardous chemical goods automatic inventory module 270.

The vehicle anti-theft alarm module 210 is configured to monitor an illegal position movement or abnormal startup of a vehicle in a parking state, and transmit monitoring information to the data storage module and the edge computing module of the vehicle-mounted gateway unit or to the remote management unit through a network communication module of the vehicle-mounted gateway unit;
the vehicle anti-robbery monitoring module 220 is configured to monitor armed persons and an abnormal gathering of persons around the vehicle, and transmit monitoring information to the data storage module and the edge computing module of the vehicle-mounted gateway unit or to the remote management unit through the network communication module of the vehicle-mounted gateway unit;
the vehicle anti-theft/robbery positioning and tracking module 230 is configured to perform positioning and tracking on a real-time position of the vehicle after an anti-theft/robbery alarm is triggered, and transmit tracked positioning information to the remote management unit through the network communication module of the vehicle-mounted gateway unit;
the vehicle fuel tank security monitoring module 240 is configured to perform real-time video monitoring on a position of a fuel tank of a truck carrying hazardous chemicals, and transmit monitoring information to the data storage module and the edge computing module of the vehicle-mounted gateway unit or to the remote management unit through the network communication module of the vehicle-mounted gateway unit;
the access control intrusion detection module 250 is configured to monitor a compartment door body of a truck carrying explosive hazardous chemicals or an inlet/outlet pipeline/an oil discharge valve of an oil pump of a tanker, and transmit monitoring information to the data storage module and the edge computing module of the vehicle-mounted gateway unit or to the remote management unit through the network communication module of the vehicle-mounted gateway unit;
the goods anti-theft video monitoring module 260 is configured to perform video monitoring on goods inside a closed van truck carrying hazardous chemicals and all openings of the tanker, and transmit monitoring information to the data storage module and the edge computing module of the vehicle-mounted gateway unit or to the remote management unit through the network communication module of the vehicle-mounted gateway unit; and
the hazardous chemical goods automatic inventory module 270 is configured to perform real-time registration on a quantity change in a loading process and a quantity change in an unloading process of the hazardous chemical goods, perform regular or irregular quantity inventory on the carried explosive hazardous chemical goods, and transmit registration and inventory information to the data storage module and the edge computing module of the vehicle-mounted gateway unit or to the remote management unit through the network communication module of the vehicle-mounted gateway unit.

Further, as shown in FIG. 1, FIG. 3, and FIG. 12, the vehicle-mounted hazardous chemicals anti-theft/robbery monitoring and early warning unit 200 thus set may monitor an illegal position movement or abnormal startup when the vehicle is in a parking state through the vehicle anti-theft alarm module 210, monitor armed persons and an abnormal gathering of persons around the vehicle through the vehicle anti-robbery monitoring module 220, perform positioning and tracking on a real-time position of the vehicle after an anti-theft/robbery alarm is triggered through the vehicle anti-theft/robbery positioning and tracking module 230, perform real-time video monitoring on a position such as a compartment door body of a truck carrying hazardous chemical goods or an inlet/outlet pipeline/an oil discharge valve of an oil pump of a tanker through the video monitoring module 240 outside the vehicle body, monitor compartment access control of a truck carrying explosive hazardous chemical goods or an inlet/outlet pipeline/an oil discharge valve of an oil pump of a tanker through the access control intrusion detection module 250, perform video monitoring on goods inside a closed van truck carrying the hazardous chemicals, and all openings of the tanker through the goods anti-theft video monitoring module 260, perform real-time registration on a quantity change in a loading process and a quantity change in an unloading process of hazardous chemicals through the hazardous chemical goods automatic inventory module 270, and perform periodic or irregular quantity inventory on the carried explosive hazardous chemicals; and

In addition, the vehicle-mounted hazardous chemicals anti-theft/robbery monitoring and early warning unit 200 may further upload monitoring information and an inventory result to the data storage module 420 of the vehicle-mounted gateway unit 400 through the network communication module 410 of the vehicle-mounted gateway unit 400, and perform intelligent analysis through the edge computing module 430 of the vehicle-mounted gateway unit 400. When a detection result or an intelligent analysis result of the monitored object triggers an early warning or an alarm, early warning information is issued, and an early warning is triggered. The early warning information is sent to the remote management unit 600 through the network communication module 410 of the vehicle-mounted gateway unit 400, and local early warning sound and light or a voice prompt is simultaneously issued through the alarm prompt unit 500.

As shown in FIG. 1, the hazardous chemical transportation emergency rescue guidance unit 300 in this system is set in a vehicle cab and driver and passenger service client software, is associated with the vehicle-mounted gateway unit 400, and is associated with the alarm prompt unit 500 and the remote management unit 600 through the vehicle-mounted gateway unit 400.

The hazardous chemical transportation emergency rescue guidance unit 300 may issue an on-site voice prompt for emergency disposal or file push guidance for a vehicle driver when a vehicle triggers a vehicle-mounted hazardous chemicals physical and chemical safety monitoring and early warning and a vehicle-mounted hazardous chemicals anti-theft/robbery monitoring and early warning.

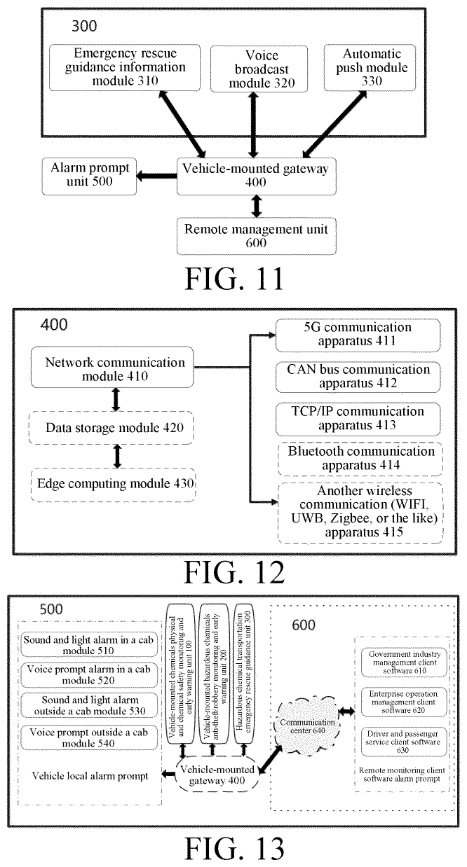

FIG. 11 is a schematic diagram of a constitutional principle and a use process of a hazardous chemical transportation emergency rescue guidance unit 300 of a vehicle-mounted hazardous chemicals safety monitoring system provided in this example.

As shown in FIG. 11, the hazardous chemical transportation emergency rescue guidance unit 300 provided in this example includes an emergency rescue guidance information module 310, a voice broadcast module 320, and an automatic push module 330 that cooperate with each other.

The emergency rescue guidance information module 310 is configured to provide guidance information such as emergency rescue guidance information of hazardous chemicals, and may be set in the data storage module of the vehicle-mounted gateway unit or the remote management unit;
the voice broadcast module 320 is configured to perform voice broadcast on emergency rescue guidance information in real time when an early warning and an alarm occur, to guide a driver and a passenger to perform preliminary emergency disposal, and may be set separately or share the voice prompt module of the alarm prompt unit; and
the automatic push module 330 is configured to push an emergency rescue guidance information file in real time when the early warning and the alarm occur, to guide the driver and the passenger to perform preliminary emergency disposal, and a push display apparatus may be disposed separately or use a driver and passenger client.

Further, as shown in FIG. 1, FIG. 11, and FIG. 12, the hazardous chemical transportation emergency rescue guidance unit 300 thus set may provide guidance information such as emergency rescue knowledge of hazardous chemicals through the data storage module 420 of the vehicle-mounted gateway unit 400 or the emergency rescue guidance information module 310 of the remote management unit 600, perform voice broadcast in real time of the emergency rescue guidance information through the voice broadcast module 320 when an early warning and an alarm occur, to guide the driver and passenger to perform preliminary emergency disposal, and push the emergency rescue guidance information file in real time through the automatic push module 330 when the early warning and the alarm occur, to guide the driver and passenger to perform preliminary emergency disposal.

As shown in FIG. 1, the vehicle-mounted gateway unit 400 in this system is set in the vehicle cab, and is respectively associated with the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, the alarm prompt unit 500, and the remote management unit 600.

The vehicle-mounted gateway unit 400 includes at least a network communication function, a data storage function, and an edge computing function; and The vehicle-mounted gateway unit 400 may establish a communication channel with the remote management unit 600, to analyze sensor monitoring data information generated by the vehicle-mounted hazardous chemicals physical and chemical safety monitoring and early warning unit and the vehicle-mounted hazardous chemicals anti-theft/robbery monitoring and early warning unit.

When an analysis result triggers an alarm, alarm information is sent to the remote management unit and the alarm prompt unit respectively, management instructions such as threshold setting and adjustment of the remote management unit and the emergency rescue guidance information of hazardous chemical transportation are sent to the vehicle-mounted hazardous chemicals physical and chemical safety monitoring and early warning unit, the vehicle-mounted hazardous chemicals anti-theft/robbery monitoring and early warning unit, and the hazardous chemical transportation emergency rescue guidance unit.

FIG. 12 is a schematic diagram of a constitutional principle of a vehicle-mounted gateway unit 400 of a vehicle-mounted hazardous chemicals safety monitoring system provided in this example and a network communication module thereof.

As shown in FIG. 12, the vehicle-mounted gateway unit 400 provided in this example includes a network communication module 410, a data storage module 420, and an edge computing module 430 that are in combination with other.

The network communication module 410 is configured to perform data exchange between the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit and the remote management unit, forward the monitoring information uploaded by the vehicle-mounted hazardous chemicals physical and chemical safety monitoring and early warning unit and the vehicle-mounted hazardous chemicals anti-theft/robbery monitoring and early warning unit and the analysis result to the remote management unit, or forward the alarm instruction and the voice prompt instruction information to the alarm prompt unit according to the received remote management unit instruction, and forward instruction information such as alarm threshold setting and adjustment and circuit control to the related monitoring apparatuses of the vehicle-mounted hazardous chemicals physical and chemical safety monitoring and early warning unit and the vehicle-mounted hazardous chemicals anti-theft/robbery monitoring and early warning unit.

The data storage module 420 is configured to store monitoring information uploaded by the vehicle-mounted hazardous chemicals physical and chemical safety monitoring and early warning unit and the vehicle-mounted hazardous chemicals anti-theft/robbery monitoring and early warning unit and an emergency rescue guidance information file of the hazardous chemical transportation emergency rescue guidance unit.

The edge computing module 430 is configured to perform intelligent analysis and determining on the monitoring information uploaded by the vehicle-mounted hazardous chemicals physical and chemical safety monitoring and early warning unit and the vehicle-mounted hazardous chemicals anti-theft/robbery monitoring and early warning unit.

As shown in FIG. 1 and FIG. 12, the vehicle-mounted gateway unit 400 thus set performs communication connection and data exchange on various apparatuses installed by the vehicle-mounted hazardous chemicals physical and chemical safety monitoring and early warning unit 100, the vehicle-mounted hazardous chemicals anti-theft/robbery monitoring and early warning unit 200, and the hazardous chemical transportation emergency rescue guidance unit 300 through the network communication module 410, implement information exchange between the alarm prompt unit 500 and the remote management unit 600, aggregate and store monitoring data of various sensors through the data storage module 420, and perform intelligent analysis on various monitoring data through the edge computing module 430.

When the vehicle-mounted gateway unit 400 receives the monitoring information from the vehicle-mounted hazardous chemicals physical and chemical safety monitoring and early warning unit 100 and the vehicle-mounted hazardous chemicals anti-theft/robbery monitoring and early warning unit 200, and analyzes and determines that hazardous chemicals explosion or theft/robbery-related early warning and alarm is triggered, the vehicle-mounted gateway unit 400 sends a sound and light alarm or voice prompt information to the alarm prompt unit 500 and sends early warning and alarm information and real-time monitoring information to the remote management unit 600; and when receiving an alarm instruction, a voice prompt instruction, alarm threshold setting and adjustment, or emergency rescue guidance information sent by the remote management unit 600, the vehicle-mounted gateway unit 400 sends the alarm instruction and the voice prompt instruction information to the alarm prompt unit 500, sends the alarm threshold setting and adjustment and circuit control instruction information to a related monitoring apparatus of the vehicle-mounted hazardous chemicals physical and chemical safety monitoring and early warning unit 100 and the vehicle-mounted hazardous chemicals anti-theft/robbery monitoring and early warning unit 200 to adjust an alarm threshold of a monitoring sensor and start a positioning and tracking apparatus or a related operation of a related pinhole camera, and sends emergency rescue guidance voice broadcast information to a voice broadcast module of the hazardous chemical transportation emergency rescue guidance unit 300 to guide a driver and a passenger to perform preliminary emergency disposal.

As shown in FIG. 1, the alarm prompt unit 500 in this system includes a vehicle local alarm prompt subunit and a remote monitoring client software alarm prompt subunit. A vehicle local alarm prompt subunit (such as a local sound and light alarm or a voice prompt apparatus) is disposed in a vehicle cab during transportation and outside the vehicle, and is connected to the vehicle-mounted gateway unit 400. A remote monitoring client software alarm prompt subunit is set in the government industry management client software, the enterprise operation management client software, and the driver and passenger service client software in the remote management unit 600, and is connected to the vehicle-mounted gateway unit 400.

The vehicle local alarm prompt subunit in the alarm prompt unit 500 may issue a voice prompt or a sound and light alarm according to the monitoring and analysis result sent by the vehicle-mounted gateway unit; and the remote monitoring client software alarm prompt subunit in the alarm prompt unit 500 may issue a voice or text prompt according to the monitoring and analysis result sent by the vehicle-mounted gateway unit.

FIG. 13 is a schematic diagram of a constitutional principle and a use process of an alarm prompt unit 500 of a vehicle-mounted hazardous chemicals safety monitoring system provided in this example.

As shown in FIG. 13, the alarm prompt unit 500 provided in this example includes vehicle local alarm prompt subunits such as a sound and light alarm in a cab module 510, a voice prompt in a cab module 520, a sound and light alarm outside a cab module 530, a voice prompt outside a cab module 540, and the like, and remote monitoring client software alarm prompt subunits such as government industry management client software 610, enterprise operation management client software 620, driver and passenger service client software 630, and the like that cooperate with each other.

The sound and light alarm in a cab module 510 is configured to issue a sound and light alarm when receiving the vehicle-mounted hazardous chemicals physical and chemical safety monitoring and early warning information and the vehicle-mounted hazardous chemicals anti-theft/robbery monitoring and early warning information. As an example, light emitted by the sound and light alarm of the sound and light alarm module is generally red by default.

The voice prompt in a cab module 520 is configured to issue a voice prompt when receiving the vehicle-mounted hazardous chemicals physical and chemical safety monitoring and early warning information and the vehicle-mounted hazardous chemicals anti-theft/robbery monitoring and early warning information, to prompt the driver to stop nearby or stop immediately for inspection, or perform voice broadcast when receiving the emergency rescue guidance information of vehicle-mounted hazardous chemicals, and to guide the driver and passenger to perform preliminary emergency disposal. As an example, the voice prompt in a cab module may be set separately from the sound and light alarm in a cab module or combined into a sound and light alarm.

The sound and light alarm outside a cab module 530 is configured to issue a sound and light alarm when receiving the vehicle-mounted hazardous chemicals physical and chemical safety monitoring and early warning information or the vehicle-mounted hazardous chemicals anti-theft/robbery monitoring and early warning information of a high risk level. As an example, light emitted by the sound and light alarm of the sound and light alarm module is generally red by default. A volume of the alarm sound is sufficient to alert passers-by in a noisy environment on the road.

The voice prompt outside a cab module 540 is configured to issue a voice prompt when receiving the vehicle-mounted hazardous chemicals physical and chemical safety monitoring and early warning information or the vehicle-mounted hazardous chemicals anti-theft/robbery monitoring and early warning information of a high risk level, to prompt other people on the road to hide as soon as possible or warn a gangster who is in a theft/robbery state to stop crimes. As an example, voice broadcast of the voice warning content is clear enough to be clearly understood by a listener.

The government industry management client software 610 is configured to receive alarm information forwarded by the vehicle-mounted gateway through the communication center when there is vehicle-mounted hazardous chemicals physical and chemical safety monitoring and early warning information or vehicle-mounted hazardous chemicals anti-theft/robbery monitoring and early warning information of a high risk level. As an example, when receiving the vehicle-mounted hazardous chemicals physical and chemical safety monitoring and early warning information or the vehicle-mounted hazardous chemicals anti-theft/robbery monitoring and early warning information of a high risk level, the government industry management client software starts an emergency management procedure by default according to an emergency scheme.

The enterprise operation management client software 620 is configured to receive alarm information forwarded by the vehicle-mounted gateway through the communication center when there is the vehicle-mounted hazardous chemicals physical and chemical safety monitoring and early warning information or the vehicle-mounted hazardous chemicals anti-theft/robbery monitoring and early warning information. As an example, when receiving the vehicle-mounted hazardous chemicals physical and chemical safety monitoring and early warning information or the vehicle-mounted hazardous chemicals anti-theft/robbery monitoring and early warning information of a high risk level, the enterprise operation management client software starts the emergency management procedure by default according to an emergency scheme, pushes vehicle-mounted hazardous chemical emergency rescue guidance file information to a vehicle-mounted hazardous chemicals emergency rescue guidance module, and synchronously sends the emergency alarm information to a government industry management client; and
the driver and passenger service client software 630 is configured to receive alarm information forwarded by the vehicle-mounted gateway through the communication center or push the vehicle-mounted hazardous chemical emergency rescue guidance file information when there is the vehicle-mounted hazardous chemicals physical and chemical safety monitoring and early warning information or the vehicle-mounted hazardous chemicals anti-theft/robbery monitoring and early warning information. As an example, the driver and passenger service client issues a voice prompt while issuing the alarm information.

As shown in FIG. 1 and FIG. 13, the alarm prompt unit 500 thus set may be configured to issue a sound and light alarm through the sound and light alarm in a cab module 510 when receiving the vehicle-mounted hazardous chemicals physical and chemical safety monitoring and early warning information sent by the vehicle-mounted hazardous chemicals physical and chemical safety monitoring and early warning unit 100 and the vehicle-mounted hazardous chemicals anti-theft/robbery monitoring and early warning information sent by the vehicle-mounted hazardous chemicals anti-theft/robbery monitoring and early warning unit 200;
may be configured to issue a voice prompt through the voice prompt in a cab module 520 when receiving the vehicle-mounted hazardous chemicals physical and chemical safety monitoring and early warning information sent by the vehicle-mounted hazardous chemicals physical and chemical safety monitoring and early warning unit 100 and the vehicle-mounted hazardous chemicals anti-theft/robbery monitoring and early warning information sent by the vehicle-mounted hazardous chemicals anti-theft/robbery monitoring and early warning unit 200, to prompt the driver to stop nearby or stop immediately for inspection, or perform voice broadcast when receiving the emergency rescue guidance information of vehicle-mounted hazardous chemicals sent by the hazardous chemical transportation emergency rescue guidance unit 300, and to guide the driver and passenger to perform preliminary emergency disposal;
may be configured to issue a sound and light alarm through the sound and light alarm outside a cab module 530 when receiving the vehicle-mounted hazardous chemicals physical and chemical safety monitoring and early warning information of a high risk level sent by the vehicle-mounted hazardous chemicals physical and chemical safety monitoring and early warning unit 100 or the vehicle-mounted hazardous chemicals anti-theft/robbery monitoring and early warning information sent by the vehicle-mounted hazardous chemicals anti-theft/robbery monitoring and early warning unit 200; and
may be configured to issue a voice prompt through the voice prompt outside a cab module 540 when receiving the vehicle-mounted hazardous chemicals physical and chemical safety monitoring and early warning information of a high risk level sent by the vehicle-mounted hazardous chemicals physical and chemical safety monitoring and early warning unit 100 or the vehicle-mounted hazardous chemicals anti-theft/robbery monitoring and early warning information sent by the vehicle-mounted hazardous chemicals anti-theft/robbery monitoring and early warning unit 200, to prompt other people on the road to hide as soon as possible or warn a gangster who is in a theft/robbery state to stop crimes.

The alarm prompt unit 500 thus set may be further configured to receive, through the government industry management client software 610, alarm information forwarded by the vehicle-mounted gateway unit 400 through the communication center when there is vehicle-mounted hazardous chemicals physical and chemical safety monitoring and early warning information or vehicle-mounted hazardous chemicals anti-theft/robbery monitoring and early warning information of a high risk level; and
may be configured to receive, through the enterprise operation management client software 620, alarm information forwarded by the vehicle-mounted gateway unit 400 through the communication center when there is the vehicle-mounted hazardous chemicals physical and chemical safety monitoring and early warning information or the vehicle-mounted hazardous chemicals anti-theft/robbery monitoring and early warning information. When receiving the vehicle-mounted hazardous chemicals physical and chemical safety monitoring and early warning information or the vehicle-mounted hazardous chemicals anti-theft/robbery monitoring and early warning information of a high risk level, the enterprise operation management client software starts the emergency management procedure by default according to an emergency scheme, pushes vehicle-mounted hazardous chemical emergency rescue guidance file information to a vehicle-mounted hazardous chemicals emergency rescue guidance module, and synchronously sends the emergency alarm information to a government industry management client 610; and
is configured to receive, through the driver and passenger service client software 630, alarm information forwarded by the vehicle-mounted gateway unit 400 through the communication center or push the vehicle-mounted hazardous chemical emergency rescue guidance file information when there is the vehicle-mounted hazardous chemicals physical and chemical safety monitoring and early warning information or the vehicle-mounted hazardous chemicals anti-theft/robbery monitoring and early warning information. The driver and passenger service client issues a voice prompt while issuing the alarm information.

As shown in FIG. 1, the remote management unit 600 in this system is set on a cloud platform of a government industry competent department related to vehicle transportation and/or a local storage server and/or personal handheld intelligent terminals of related management personnel, and a cloud platform of a transportation enterprise to which a vehicle belongs and a related transportation party and/or a local storage server and/or personal handheld intelligent terminals of related management personnel and personal handheld intelligent terminals of a driver and a passenger, is directly associated with the vehicle-mounted gateway unit 400 of a vehicle, and is indirectly associated with the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, and the alarm prompt unit 500 through the vehicle-mounted gateway unit 400.

The remote management unit 600 may issue an instruction to set and adjust alarm thresholds of related sensors of the vehicle-mounted hazardous chemicals physical and chemical safety monitoring and early warning unit and the vehicle-mounted hazardous chemicals anti-theft/robbery monitoring and early warning unit or send the emergency rescue guidance information to the hazardous chemical transportation emergency rescue guidance unit to perform voice broadcast guidance or video file guidance, and receive the physical and chemical safety monitoring information of vehicle-mounted hazardous chemicals and the vehicle-mounted hazardous chemicals anti-theft/robbery monitoring and early warning information sent by the vehicle-mounted gateway unit.

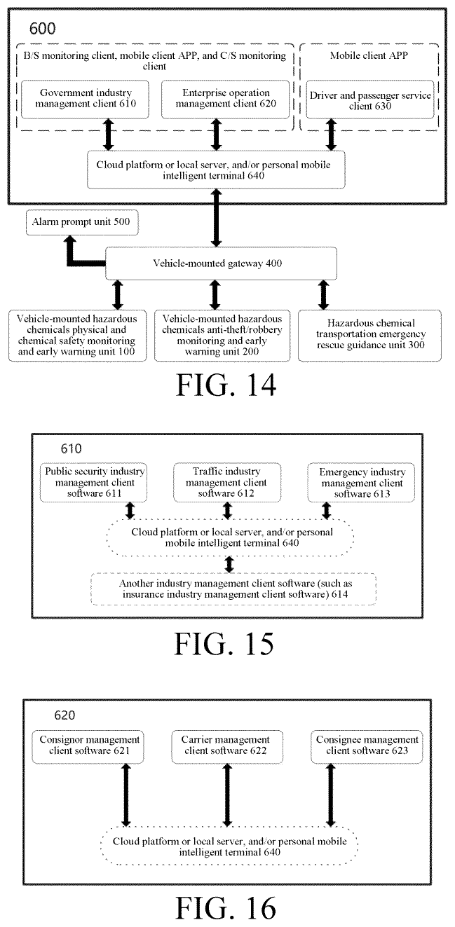

FIG. 14 is a schematic diagram of a constitutional principle and a use procedure of a remote management unit 600 of a vehicle-mounted hazardous chemicals safety monitoring system provided in this example.

As shown in FIG. 14, the remote management unit 600 provided in this example includes government industry management client software 610, enterprise operation management client software 620, driver and passenger service client software 630, and a communication center (a cloud platform or a local server and/or a personal mobile intelligent terminal) 640 that cooperate with each other.

The government industry management client software 610 of the remote management unit 600 is configured to receive and display vehicle-mounted hazardous chemicals physical and chemical safety monitoring and early warning information or vehicle-mounted hazardous chemicals anti-theft/robbery monitoring and early warning information of a high risk level forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, issue a related management instruction according to the received early warning and alarm information, start an emergency management procedure, and issue a related emergency disposal instruction.

The enterprise operation management client software 620 of the remote management unit 600 is configured to receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, and issue the related management instruction or emergency rescue guidance information according to the received early warning and alarm information; and when receiving the vehicle-mounted hazardous chemicals physical and chemical safety monitoring and early warning information or the vehicle-mounted hazardous chemicals anti-theft/robbery monitoring and early warning information of a high risk level, start the emergency management procedure, push vehicle-mounted hazardous chemical emergency rescue guidance file information to a vehicle-mounted hazardous chemicals emergency rescue guidance module, send an emergency alarm to a government industry management client, and issue the related emergency disposal instruction.

The driver and passenger service client software 630 of the remote management unit 600 is configured to receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, issue a sound and light alarm, a voice prompt, and emergency rescue guidance corresponding to alarm and early warning information according to the received alarm and early warning information, prompt a driver to stop nearby or immediately stop for inspection, and provide a corresponding emergency disposal guidance scheme.

The communication center 640 of the remote management unit 600 is configured to communicate with the vehicle-mounted gateway unit, receive and store the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit, and separately forward to the government industry management client software, the enterprise operation management client software, and the driver and passenger service client software. The communication center also serves as a computer system environment for the government industry management client software, the enterprise operation management client software, and the driver and passenger service client software, to support related software applications, and forwards management instructions or response instructions of the government industry management client software, the enterprise operation management client software, and the driver and passenger service client software to the vehicle-mounted gateway unit.

As shown in FIG. 1 and FIG. 14, the remote management unit 600 thus set may receive and display, through the government industry management client software 610, vehicle-mounted hazardous chemicals physical and chemical safety monitoring and early warning information or vehicle-mounted hazardous chemicals anti-theft/robbery monitoring and early warning information of a high risk level forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 300 and through the communication center 640, issue a related management instruction according to the received early warning and alarm information, start an emergency management procedure, and issue a related emergency disposal instruction;
through the enterprise operation management client software 620, receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 300 and through the communication center 640, and issue the related management instruction or emergency rescue guidance information according to the received early warning and alarm information; when receiving the vehicle-mounted hazardous chemicals physical and chemical safety monitoring and early warning information or the vehicle-mounted hazardous chemicals anti-theft/robbery monitoring and early warning information of a high risk level, start the emergency management procedure, push vehicle-mounted hazardous chemical emergency rescue guidance file information to a vehicle-mounted hazardous chemicals emergency rescue guidance module, send an emergency alarm to a government industry management client 610, and issue the related emergency disposal instruction;
through the driver and passenger service client software 630, receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 300 and through the communication center 640, issue a sound and light alarm, a voice prompt, and emergency rescue guidance corresponding to alarm and early warning information according to the received alarm and early warning information; and
through the communication center 640, communicate with the vehicle-mounted gateway unit 300, receive and store the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400, and separately forward to the government industry management client software 610, the enterprise operation management client software 620, and the driver and passenger service client software 630. The communication center 640 also serves as a computer system environment for the government industry management client software 610, the enterprise operation management client software 620, and the driver and passenger service client software 630, to support related software applications, and forwards management instructions or response instructions of the government industry management client software 610, the enterprise operation management client software 620, and the driver and passenger service client software 630 to the vehicle-mounted gateway unit 400.

The vehicle-mounted hazardous chemicals safety monitoring system 700 thus formed may perform real-time monitoring on temperature of vehicle-mounted hazardous chemicals and temperature in a compartment through the temperature monitoring module of the vehicle-mounted hazardous chemicals physical and chemical safety monitoring and early warning unit 100, perform real-time monitoring on humidity of the vehicle-mounted hazardous chemicals and humidity in the compartment through the humidity monitoring module of the vehicle-mounted hazardous chemicals physical and chemical safety monitoring and early warning unit, perform real-time monitoring on pressure of the vehicle-mounted hazardous chemicals and pressure in the compartment or in the tank through the pressure monitoring module of the vehicle-mounted hazardous chemicals physical and chemical safety monitoring and early warning unit, perform real-time monitoring on vibration in the compartment or the tank in the vehicle carrying the hazardous chemicals through the vibration monitoring module of the vehicle-mounted hazardous chemicals physical and chemical safety monitoring and early warning unit, perform real-time monitoring on leakage of the vehicle-mounted hazardous chemicals and leakage of gas in the compartment or leakage of gas or liquid of an outlet of the tank in the vehicle carrying the vehicle-mounted hazardous chemicals through the leakage monitoring module of the vehicle-mounted hazardous chemicals physical and chemical safety monitoring and early warning unit. When the temperature, the humidity, the pressure, the vibration intensity, or a leakage monitoring result are higher than a set threshold, and there may be risks of combustion, explosion, and leakage of the hazardous chemicals, early warning information is issued, and an early warning is triggered. The early warning information is sent to the remote management unit, and local early warning sound and light or a voice prompt is simultaneously issued through the alarm prompt unit.

The system further synchronously monitors an illegal position movement or abnormal startup when the vehicle is in a parking state through the vehicle anti-theft alarm module of the vehicle-mounted hazardous chemicals anti-theft/robbery monitoring and early warning unit 200, monitors armed persons and an abnormal gathering of persons around the vehicle through the vehicle anti-robbery monitoring module of the vehicle-mounted hazardous chemicals anti-theft/robbery monitoring and early warning unit, performs positioning and tracking on a real-time position of the vehicle after an anti-theft/robbery alarm is triggered through the vehicle anti-theft/robbery positioning and tracking module of the vehicle-mounted hazardous chemicals anti-theft/robbery monitoring and early warning unit, performs real-time video monitoring on a position such as a compartment door body of a truck carrying hazardous chemical goods or an inlet/outlet pipeline/an oil discharge valve of an oil pump of a tanker through the video monitoring module outside the vehicle body of the vehicle-mounted hazardous chemicals anti-theft/robbery monitoring and early warning unit, monitors compartment access control of a truck carrying explosive hazardous chemical goods or an inlet/outlet pipeline/an oil discharge valve of an oil pump of a tanker through the access control intrusion detection module of the vehicle-mounted hazardous chemicals anti-theft/robbery monitoring and early warning unit, performs video monitoring on goods inside a closed van truck carrying the hazardous chemicals, and all openings of the tanker through the goods anti-theft video monitoring module of the vehicle-mounted hazardous chemicals anti-theft/robbery monitoring and early warning unit, performs real-time registration on a quantity change in a loading process and a quantity change in an unloading process of hazardous chemicals through the hazardous chemical goods automatic inventory module of the vehicle-mounted hazardous chemicals anti-theft/robbery monitoring and early warning unit, and performs periodic or irregular quantity inventory on the carried explosive hazardous chemicals. When a detection result or an intelligent analysis result of the monitored object triggers an early warning or an alarm, early warning information is issued

This system further synchronously issues an on-site voice prompt for emergency disposal or file push guidance for a vehicle driver through the hazardous chemical transportation emergency rescue guidance unit 300 when a vehicle triggers a physical and chemical safety monitoring and early warning on vehicle-mounted hazardous chemicals and an anti-theft/robbery monitoring and early warning on vehicle-mounted hazardous chemicals.

The vehicle-mounted gateway unit 400 in this system performs communication connection and data exchange on various apparatuses installed by the vehicle-mounted hazardous chemicals physical and chemical safety monitoring and early warning unit, the vehicle-mounted hazardous chemicals anti-theft/robbery monitoring and early warning unit, and the hazardous chemical transportation emergency rescue guidance unit through the network communication module, implement information exchange between the alarm prompt unit and the remote management unit, aggregate and store monitoring data of various sensors through the data storage module, and perform intelligent analysis on various monitoring data through the edge computing module. When intelligent analysis results of various monitoring data trigger an early warning or alarm, the vehicle-mounted gateway unit sends the early warning or alarm information to the alarm prompt unit and the remote management unit respectively through the network communication module, the alarm prompt unit issues the sound and light alarm or the voice prompt in the local cab or outside the cab through the sound and light alarm in a cab module and/or the voice prompt module, the sound and light alarm outside a cab module and/or the voice prompt module and/or the remote alarm prompt module, and the remote management unit may respectively display the alarm prompt results or set early warning and alarm thresholds of related sensors through the government industry management client, the enterprise operation management client, and the driver and passenger service client.

In this way, in an automatic monitoring and transportation process, the physical and chemical safety and anti-theft/robbery safety information of vehicle-mounted hazardous chemicals is implemented. When vehicle-mounted hazardous chemicals are at a risk of explosion or being theft/robbed, a sound and light early warning and alarm or a voice prompt is issued to the driver and passenger, to prompt the driver and passenger to get off the vehicle in time for inspection or prepare for defense. In addition, safety monitoring, early warning, and alarm information of vehicle-mounted hazardous chemicals is uploaded to the enterprise to which the vehicle belongs and the competent industry department, an on-site voice prompt for emergency disposal or file push guidance is issued, and emergency rescue is quickly started, which is of great significance to improving monitoring, early warning, and prevention capabilities on hazardous chemical transportation safety accidents, improving emergency disposal efficiency of hazardous chemical transportation safety accidents, and anti-terrorism prevention capabilities on hazardous chemical transportation.

Based on this, this example further clarifies specific apparatuses that may be involved in a composition module of each unit of the vehicle-mounted hazardous chemicals safety monitoring system, and describes a feasible deployment scheme for a corresponding unit module by using examples.

With reference to FIG. 1 and FIG. 2, when being deployed, preferably, the vehicle-mounted hazardous chemicals physical and chemical safety monitoring and early warning unit 100 in this system is directly associated with the vehicle-mounted gateway unit 400, and is indirectly associated with a vehicle alarm prompt unit 500 and a remote management unit 600 through the vehicle-mounted gateway unit 400.

Various monitoring apparatuses of the temperature monitoring module 110, the humidity monitoring module 120, the pressure monitoring module 130, the vibration monitoring module 140, and the leakage monitoring module 150 of the vehicle-mounted hazardous chemicals physical and chemical safety monitoring and early warning unit 100 thus deployed send monitoring information to the network communication module of the vehicle-mounted gateway 400, aggregate monitoring data to a data storage module of the vehicle-mounted gateway, and perform intelligent analysis through the edge computing module of the vehicle-mounted gateway unit 400; and when risks of combustion, explosion, and leakage of hazardous chemicals occur, send a corresponding sound and light alarm or voice prompt to the alarm prompt unit 500 through the network communication module of the vehicle-mounted gateway unit 400, and simultaneously upload alarm prompt information to the remote management unit 600 through the network communication module of the vehicle-mounted gateway.

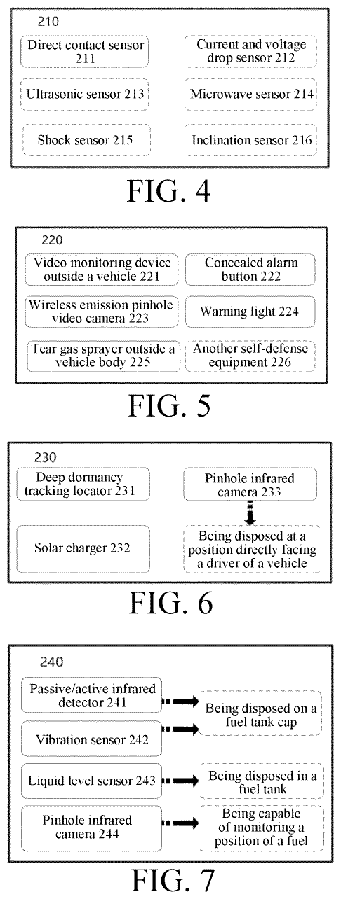

FIG. 2 and FIG. 4 show schematic diagrams of composition of a vehicle anti-theft alarm module 210 of an anti-theft/robbery monitoring and early warning unit provided in this example.

As shown in FIG. 4, the vehicle anti-theft alarm module 210 of the anti-theft/robbery monitoring and early warning unit 200 includes a direct contact sensor 211 and/or a current and voltage drop sensor 212 and/or an ultrasonic sensor 213 and/or a microwave sensor 214 and/or a shock sensor 215 and/or an inclination sensor 216.

The direct contact sensor 211 is configured to trigger an alarm when a door, a trunk, or a rear hatch is forced to open;
the current and voltage drop sensor 212 is configured to monitor changes in a vehicle circuit system, and trigger an alarm when the vehicle circuit system changes;
the ultrasonic sensor 213 is configured to monitor changes in air pressure in a vehicle cab, and triggers an alarm when a window is broken or someone enters the vehicle cab while a vehicle is in a parking state;
the microwave sensor 214 is configured to monitor a solid object passing through a light beam emitted from all entry points in the vehicle cab, and triggers the alarm when someone enters the vehicle cab while the vehicle is in the parking state;
the shock sensor 215 is configured to monitor a sudden shock of the vehicle, and triggers the alarm when someone tries to break the glass and enter the vehicle cab or destroy the vehicle; and
the inclination sensor 216 is configured to monitor sudden inclination of the vehicle, and triggers an alarm when someone tries to tow the vehicle away.

FIG. 2 and FIG. 5 show schematic schemes of composition of a vehicle anti-robbery monitoring module 220 of an anti-theft/robbery monitoring and early warning unit of a vehicle-mounted hazardous chemicals safety monitoring system provided in this example.

As shown in FIG. 5, the vehicle anti-robbery monitoring module 220 of the anti-theft/robbery monitoring and early warning unit 200 provided in this example includes a video monitoring device outside a vehicle 221, a concealed alarm button 222, a wireless emission pinhole video camera 223, a warning light 224, a tear gas sprayer outside a vehicle body 225, and another self-defense equipment 226.

The video monitoring device outside a vehicle 221 is configured to collect an image of a person around the vehicle, and triggers an alarm when a plurality of armed persons approach or an abnormal gathering of persons occurs;
the concealed alarm button 222 is configured to issue a robbery emergency alarm when a driver has confirmed that a robbery event occurs;
the wireless emission pinhole video camera 223 is configured to collect a behavior image of a gangster in a robbery state outside the vehicle body when the robbery emergency alarm is triggered;
the tear gas sprayer outside a vehicle body 224 is configured to automatically release commonly used tear gas sprays such as CS (o-chlorobenzylidene malononitrile) and/or CN (phenyl chloroacetophenone) and/or OC (capsaicin), or the like when the robbery emergency alarm is triggered;
the warning light 225 is configured to continuously flash on the roof of the vehicle when the robbery emergency alarm is triggered, psychologically deter the gangster at the scene of the robbery, and guide a position of the vehicle for the police rushing to the scene of the robbery; and
the another self-defense equipment 226 includes but is not limited to a strong light flashlight, a swing stick, a flash bomb, or a small dry powder fire extinguisher, and is configured to delay a robbery action committed by the gangster by the driver and the passenger when a robbery emergency alarm is triggered, to improve a sense of safety and self-defense capabilities of the driver and the passenger.

FIG. 2 and FIG. 6 show schematic schemes of specific composition of a vehicle anti-theft/robbery positioning and tracking module 230 of an anti-theft/robbery monitoring and early warning unit of a vehicle-mounted hazardous chemicals safety monitoring system provided in this example.

As shown in FIG. 6, the vehicle anti-theft/robbery positioning and tracking module 230 of the anti-theft/robbery monitoring and early warning unit 200 provided in this example includes a deep dormancy tracking locator 231, a solar charger 232, and a pinhole infrared camera 233 at a driver's position of a vehicle.

The deep dormancy tracking locator 231 is configured to start real-time positioning after the vehicle is theft/robbed and a satellite positioning system of a vehicle-mounted terminal unit is destroyed or powered off; and as an example, the tracking locator includes but is not limited to Beidou satellite positioning and/or GPS positioning and/or GLONASS positioning and/or GSNS satellite positioning.

The solar charger 232 is configured to charge the deep dormancy tracking locator, to ensure that the deep dormancy tracking locator is in an operating state after being started. The pinhole infrared camera 233 at a driver's position of a vehicle is configured to collect, in real time, an image of a person at the driver's position of the vehicle after the deep dormancy tracking locator is started.

FIG. 2 and FIG. 7 show schematic schemes of specific composition of a vehicle fuel tank security monitoring module 240 of an anti-theft/robbery monitoring and early warning unit of a vehicle-mounted hazardous chemicals safety monitoring system provided in this example.

As shown in FIG. 7, the vehicle fuel tank security monitoring module 240 of the anti-theft/robbery monitoring and early warning unit 200 provided in this example includes an infrared detector 241 disposed on a fuel tank cap, a vibration sensor 242, a liquid level sensor 243 disposed in a fuel tank, and/or a pinhole infrared camera 244 that is capable of monitoring a position of a fuel tank in real time.

The infrared detector 241 is configured to detect a person approaching a fuel tank in an armed state in which the fuel tank does not need to be refueled, and triggers an alarm when a person enters a detection area in the armed state;
the vibration sensor 242 is configured to detect abnormal vibration of a fuel tank cap in the armed state in which the fuel tank does not need to be refueled, and triggers an alarm when the fuel tank cap vibrates in the armed state;
the liquid level sensor 243 in the fuel tank is configured to detect an abnormal drop of a gasoline or diesel liquid level in the fuel tank, and triggers an alarm when the oil level drops rapidly in the armed state; and
the pinhole infrared camera 244 that is capable of monitoring the position of the fuel tank is configured to collect the image of the person approaching the fuel tank in the armed state in which the fuel tank does not need to be refueled, and starts the camera when a vehicle fuel tank security monitoring alarm is triggered.

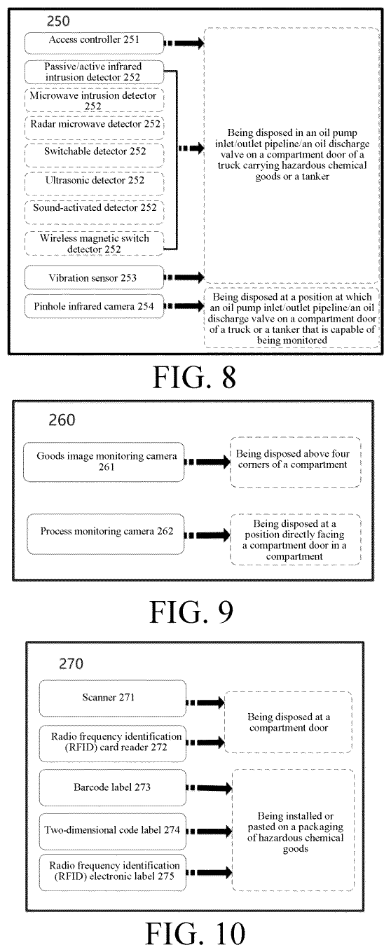

FIG. 2 and FIG. 8 show schematic schemes of specific composition of an access control intrusion detection module 250 of an anti-theft/robbery monitoring and early warning unit of a vehicle-mounted hazardous chemicals safety monitoring system provided in this example.

As shown in FIG. 8, the access control intrusion detection module 250 of the anti-theft/robbery monitoring and early warning unit 200 provided in this example includes an access controller 251 disposed on a compartment door of a truck carrying hazardous chemical goods or an inlet/outlet pipeline/an oil discharge valve of an oil pump of a tanker, a passive infrared intrusion detector 252 (in addition, an active infrared intrusion detector or a microwave intrusion detector or a radar microwave detector or a switchable detector or an ultrasonic detector or a sound-activated detector or a wireless magnetic switch detector may alternatively be selected and used), a vibration sensor 253, and a pinhole camera 254 that is capable of monitoring a position of a compartment door of a truck or an inlet/outlet pipeline/an oil discharge valve of an oil pump of a tanker in real time.

The access controller 251 is configured to control opening and closing of the compartment door of the truck carrying hazardous chemical goods or the inlet/outlet pipeline/the oil discharge valve of the oil pump of the tanker, and triggers an alarm when abnormal opening occurs;
the passive infrared intrusion detector and/or the active infrared intrusion detector and/or the microwave intrusion detector and/or the radar microwave detector and/or the switchable detector and/or the ultrasonic detector and/or the sound-activated detector and/or the wireless magnetic switch detector 252 is configured to detect abnormal approaching of a person or abnormal opening of the compartment door, the inlet/outlet pipeline/the oil discharge valve in the armed state, and an alarm is triggered when abnormal approaching of a person or abnormal opening of the compartment door, the inlet/outlet pipeline/the oil discharge valve in the armed state occurs;
the vibration sensor 253 is configured to trigger an alarm when abnormal vibration of the compartment door, the inlet/outlet pipeline/the oil discharge valve in the armed state occurs, and when the compartment door, the inlet/outlet pipeline/the oil discharge valve vibrates in the armed state; and
the pinhole camera 254 at the position of the compartment door of the truck or the inlet/outlet pipeline/the oil discharge valve of the oil pump of the tanker is configured to collect an image of a person approaching the compartment door, the inlet/outlet pipeline/the oil discharge valve in the armed state, and start the camera when the access control intrusion monitoring alarm is triggered.

The specific use of the passive infrared intrusion detector or other types of intrusion detectors in this example may be determined according to structural characteristics of an actual vehicle and needs of different users, and is not limited herein.

FIG. 2 and FIG. 9 show schematic schemes of specific composition of a goods anti-theft video monitoring module 260 of an anti-theft/robbery monitoring and early warning unit of a vehicle-mounted hazardous chemicals safety monitoring system provided in this example.

As shown in FIG. 9, the goods anti-theft video monitoring module 260 of the anti-theft/robbery monitoring and early warning unit 200 provided in this example includes but is not limited to a goods image monitoring camera 261 disposed above four corners of a compartment and a process monitoring camera 262 that directly faces a compartment door and that is disposed in the compartment.

The goods image monitoring camera 261 is disposed above four corners of the compartment, and is configured to collect a real-time image of the hazardous chemical goods after being carried; and the process monitoring camera 262 is disposed at a position in the compartment that directly faces the compartment door, and is configured to collect an image of a loading process and an unloading process.

FIG. 2 and FIG. 10 show schematic schemes of specific composition of a hazardous chemical goods automatic inventory module 270 of an anti-theft/robbery monitoring and early warning unit of a vehicle-mounted hazardous chemicals safety monitoring system provided in this example.

As shown in FIG. 10, the hazardous chemical goods automatic inventory module 270 of the anti-theft/robbery monitoring and early warning unit 200 provided in this example includes a code scanner 271 or a radio frequency identification (RFID) card reader 272 disposed at the compartment door, a barcode label 273, a two-dimensional code label 274, or a radio frequency identification (RFID) electronic label 275 installed or pasted on the packaging of the hazardous chemical goods.

The code scanner 271 or the radio frequency identification (RFID) card reader 272 is configured to read the barcode label 273, the two-dimensional code label 274, or the radio frequency identification (RFID) electronic label 275 on the packaging of the hazardous chemical goods; and
the barcode label 273, the two-dimensional code label 274, or the radio frequency identification (RFID) electronic label 275 is configured to be pasted on the packaging of the hazardous chemical goods, to perform reading statistics in a process of loading and unloading.

The combined configuration of the radio frequency identification (RFID) card reader 272 and the radio frequency identification (RFID) electronic label 275 may be configured to perform periodic or irregular inventory in a process of transportation. The specific use of the code scanner or the radio frequency identification (RFID) card reader may be determined according to the nature of the label on the outer packaging of the hazardous chemicals, which is not limited herein.

When the vehicle-mounted hazardous chemicals anti-theft/robbery monitoring and early warning unit 200 thus constituted is deployed, preferably, the vehicle-mounted hazardous chemicals anti-theft/robbery monitoring and early warning unit 200 is directly associated with the vehicle-mounted gateway unit 400, and is indirectly associated with a vehicle alarm prompt unit 500 and a remote management unit 600 through the vehicle-mounted gateway unit 400. In this way, various monitoring apparatuses, detection apparatuses, and cameras of a vehicle anti-theft alarm module, a vehicle anti-robbery monitoring module, a vehicle anti-theft/robbery positioning and tracking module, a vehicle fuel tank security monitoring module, an access control intrusion detection module, a goods anti-theft video monitoring module, and/or a hazardous chemical goods automatic inventory module of the vehicle-mounted hazardous chemicals anti-theft/robbery monitoring and early warning unit aggregate monitoring data to the data storage module of the vehicle-mounted gateway through the network communication module of the vehicle-mounted gateway, and perform intelligent analysis through the edge computing module of the vehicle-mounted gateway unit, and when a corresponding anti-theft/robbery warning is triggered, send a corresponding sound and light alarm or voice prompt to the alarm prompt unit through the network communication module of the vehicle-mounted gateway unit, and simultaneously upload the alarm prompt information to the remote management unit through the network communication module of the vehicle-mounted gateway.

With reference to FIG. 1 and FIG. 11, when being deployed, preferably, the hazardous chemical transportation emergency rescue guidance unit 300 in this example is directly associated with the vehicle-mounted gateway unit 400, and is indirectly associated with a vehicle alarm prompt unit 500 and a remote management unit 600 through the vehicle-mounted gateway unit 400.

The hazardous chemical transportation emergency rescue guidance unit 300 thus deployed may transmit the emergency rescue guidance information through the network communication module of the vehicle-mounted gateway, transmit the emergency rescue guidance information through a module of the vehicle-mounted gateway, store the emergency rescue guidance information through the data storage of the vehicle-mounted gateway unit or the remote management unit, perform voice broadcast of the emergency rescue guidance information through the voice broadcast module disposed separately or the voice prompt module of the shared alarm prompt unit, and simultaneously display the pushed emergency rescue guidance information file through a separately set display apparatus or driver and passenger client software.

Further, FIG. 12 further shows a schematic scheme of composition of a network communication module 410 in a vehicle-mounted gateway unit of a vehicle-mounted hazardous chemicals safety monitoring system.

As shown in FIG. 12, the network communication module 410 of the vehicle-mounted gateway unit 400 in this example includes but is not limited to a 5G communication apparatus 411, a CAN bus communication apparatus 412, a TCP/IP communication apparatus 413, a Bluetooth (Bluetooth) communication apparatus 414, another wireless communication (WIFI, UWB, Zigbee, or the like) apparatus 415, or the like.

The 5G communication apparatus 411 is used for communication between the vehicle-mounted gateway and the remote management unit;
the CAN bus communication apparatus 412 is used for wired communication between the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit by using the CAN bus;
the TCP/IP communication apparatus 413 is used for wired communication or wireless communication between the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, the alarm prompt unit, and the remote management unit by using the TCP/IP;
the Bluetooth (Bluetooth) communication apparatus 414 is used for wireless communication between the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit based on a Bluetooth (Bluetooth) protocol; and
the another wireless communication (WIFI, UWB, Zigbee, or the like) apparatus 415 is used for wireless communication between the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit based on corresponding protocols such as WIFI, UWB, and Zigbee.

As shown in FIG. 1 and FIG. 12, the network communication module 410 thus set may perform communication between the vehicle-mounted gateway unit 400 and the remote management unit 600 through the 5G communication apparatus 411;
may perform, through the CAN bus communication apparatus 412, wired communication between the vehicle-mounted gateway unit 400 and the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, and the alarm prompt unit 500 by using the CAN bus;
may perform, through the TCP/IP communication apparatus 413, wired communication or wireless communication between the vehicle-mounted gateway unit 400 and the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, the alarm prompt unit 500, and the remote management unit 600 by using the TCP/IP;
may perform, through the Bluetooth (Bluetooth) communication apparatus 414, wireless communication between the vehicle-mounted gateway unit 400 and the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, and the alarm prompt unit 400 based on a Bluetooth (Bluetooth) protocol; and
may perform, through the another wireless communication (WIFI, UWB, Zigbee, or the like) apparatus 415, wireless communication between the vehicle-mounted gateway unit 400 and the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, and the alarm prompt unit 500 based on corresponding protocols such as WIFI, UWB, and Zigbee.

With reference to FIG. 12, this example further shows a schematic scheme of composition of a data storage module 420 in a vehicle-mounted gateway unit 400 of a vehicle-mounted hazardous chemicals safety monitoring system.

In this example, the data storage module 420 preferably includes a built-in data storage apparatus and an external data storage apparatus.

The built-in data storage apparatus includes but is not limited to a built-in static random access memory SRAM, a built-in dynamic random access memory DRAM, and a built-in hard disk; and the external data storage apparatus includes but is not limited to an external mobile hard disk, a USB flash drive, a TF memory card, and an SD memory card.

In the scheme of this example, both the built-in data storage apparatus and the external data storage apparatus may be configured to store information of the vehicle-mounted hazardous chemicals physical and chemical safety monitoring and early warning unit, the vehicle-mounted hazardous chemicals anti-theft/robbery monitoring and early warning unit, and the hazardous chemical transportation emergency rescue guidance unit.

With reference to FIG. 12, this example further shows a schematic scheme of composition of an edge computing module 430 in a vehicle-mounted gateway unit 400 of a vehicle-mounted hazardous chemicals safety monitoring system.

Specifically, the edge computing module 430 of the vehicle-mounted gateway unit 400 includes an AI smart chip having an edge computing function and a terminal SDK having the edge computing function.

In the scheme of this example, a circuit AI smart chip having an edge computing function and the terminal SDK having the edge computing function are configured to perform intelligent analysis and determining on the monitoring information uploaded by the vehicle-mounted hazardous chemicals physical and chemical safety monitoring and early warning unit and the vehicle-mounted hazardous chemicals anti-theft/robbery monitoring and early warning unit.

When the vehicle-mounted gateway unit 400 thus constituted is deployed, preferably, the vehicle-mounted gateway unit is directly associated with the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, the alarm prompt unit 500, and the remote management unit 600.

When the vehicle-mounted gateway unit 400 is thus deployed, and when the vehicle-mounted gateway unit receives the monitoring information from the vehicle-mounted hazardous chemicals physical and chemical safety monitoring and early warning unit and the vehicle-mounted hazardous chemicals anti-theft/robbery monitoring and early warning unit, and analyzes and determines that hazardous chemicals explosion or theft/robbery-related early warning and alarm is triggered, a sound and light alarm or voice prompt information is sent to the alarm prompt unit through the vehicle-mounted gateway unit and early warning and alarm information and real-time monitoring information are sent to the remote management unit; and
when receiving an alarm instruction, a voice prompt instruction, alarm threshold setting adjustment or emergency rescue guidance information sent by the remote management unit, the vehicle-mounted gateway sends the alarm instruction and the voice prompt instruction information to the alarm prompt unit, sends the alarm threshold setting adjustment and circuit control instruction information to related monitoring apparatuses of the vehicle-mounted hazardous chemicals physical and chemical safety monitoring and early warning unit and the vehicle-mounted hazardous chemicals anti-theft/robbery monitoring and early warning unit to adjust an alarm threshold of a monitoring sensor and start a positioning and tracking apparatus or a related operation of a related pinhole camera, and sends emergency rescue guidance voice broadcast information to a voice broadcast module of the hazardous chemical transportation emergency rescue guidance unit to guide the driver and the passenger to perform preliminary emergency disposal.

Referring to FIG. 1 and FIG. 13, when the alarm prompt unit 500 is deployed in this example, preferably, the alarm prompt unit 500 is directly associated with the vehicle-mounted gateway unit 400, and is indirectly associated with the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, and the remote management unit 600 through the vehicle-mounted gateway unit 400.

When the alarm prompt unit 500 thus deployed cooperates with other units to operate, and when the local alarm prompt subunit receives vehicle-mounted hazardous chemicals physical and chemical safety monitoring and early warning information or vehicle-mounted hazardous chemicals anti-theft/robbery monitoring and early warning information of a medium risk level or a low risk level sent by the vehicle-mounted gateway, the alarm prompt unit issues a sound and light alarm in a cab and voice prompts the driver to stop nearby or stop immediately for inspection;
when the local alarm prompt subunit receives vehicle-mounted hazardous chemicals physical and chemical safety monitoring and early warning information or vehicle-mounted hazardous chemicals anti-theft/robbery monitoring and early warning information of a high risk level, the alarm prompt unit issues a sound and light alarm inside and outside a cab and voice prompts the driver to stop immediately for inspection, to prompt a passer-by to be alert to anomaly of the vehicle, avoid in time, or call the police immediately, or warn a gangster who is in a theft/robbery state to stop crimes;
when a remote monitoring client software alarm prompt subunit receives the vehicle-mounted hazardous chemicals physical and chemical safety monitoring and early warning information or the vehicle-mounted hazardous chemicals anti-theft/robbery monitoring and early warning information of a medium risk level or a low risk level, the alarm prompt unit issues an alarm prompt; and
when the remote monitoring client software alarm prompt subunit receives the vehicle-mounted hazardous chemicals physical and chemical safety monitoring and early warning information or the vehicle-mounted hazardous chemicals anti-theft/robbery monitoring and early warning information of a high risk level, the alarm prompt unit issues an emergency alarm and a voice prompt, sends the emergency rescue guidance information, and starts an emergency management procedure by default according to an emergency scheme.

FIG. 15 is a schematic diagram of a constitutional principle of a government industry management client 610 of a remote management unit 600 of a vehicle-mounted hazardous chemicals safety monitoring system in this example.

As shown in FIG. 15, the government industry management client 610 of the remote management unit 600 provided in this example includes public security industry management client software 611, traffic industry management client software 612, emergency industry management client software 613, and another industry management client software (such as insurance industry management client software) 614 according to different competent industry departments.

As shown in FIG. 1, FIG. 14, and FIG. 15, the public security industry management client software 611 of the government industry management client 610 is configured to receive and display vehicle-mounted hazardous chemicals physical and chemical safety monitoring and early warning information or vehicle-mounted hazardous chemicals anti-theft/robbery monitoring and early warning information of a high risk level forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400 and through the communication center 640, issue a traffic management instruction to the traffic police on duty on the road on which the vehicle is located according to an information type, issue traffic accident handling instructions of a corresponding vehicle and position to related traffic accident handling personnel, and issue other linkage management information such as 120 emergency rescue according to an emergency scheme setting;
the traffic industry management client software 612 of the government industry management client 610 is configured to receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400 and through the communication center 640, issue management instructions to related traffic safety responsible units according to an information type, and issue other linkage management information according to an emergency scheme setting;
the emergency industry management client software 613 of the government industry management client 610 is configured to receive and display the vehicle-mounted hazardous chemicals physical and chemical safety monitoring and early warning information or the vehicle-mounted hazardous chemicals anti-theft/robbery monitoring and early warning information of a high risk level forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400 and through the communication center 640, issue emergency disposal instructions to related emergency rescue personnel such as firefighters according to an information type, a vehicle type, a type of goods carried in a goods-carrying vehicle, and issue other linkage management information according to an emergency scheme setting; and
the another industry management client software (such as insurance industry management client software 614) of the government industry management client 610 is configured to receive and display vehicle-mounted hazardous chemicals physical and chemical safety monitoring and early warning information or vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400 and through the communication center 640, start an insurance claim service according to an information condition, and issue other linkage management information according to an emergency scheme setting. Another industry management client software supports function customization according to a corresponding industry management requirement, or autonomously selects to enable or disable related monitoring client functions in the scope of user authority.

FIG. 16 is a schematic diagram of a constitutional principle of an enterprise operation management client 620 of a remote management unit 600 of a vehicle-mounted hazardous chemicals safety monitoring system provided in this example.

As shown in FIG. 16, the enterprise operation management client 620 of the remote management unit 600 provided in this example includes consignor management client software 621, carrier management client software 622, and consignee management client software 623 according to different users.

As shown in FIG. 1, FIG. 14, and FIG. 16, the consignor management client software 621 of the enterprise operation management client 620 is configured to receive and display safety tracking and query information of a vehicle consigning goods;
the carrier management client software 622 of the enterprise operation management client 620 is configured to receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400 and through the communication center 640; when receiving the early warning and alarm information, send the emergency rescue guidance information to the driver and passenger service client 630 in a manner of text, image, voice, file, or the like; when receiving an early warning and alarm of a high risk level, send the emergency rescue guidance information to the driver and passenger service client 630 in a manner of text, image, voice, file, or the like, and immediately send linkage alarm information to the government industry management client 610 according to an emergency scheme setting; and
the consignee management client software 623 of the enterprise operation management client 620 is configured to receive and display safety tracking and query information of a vehicle consigning goods.

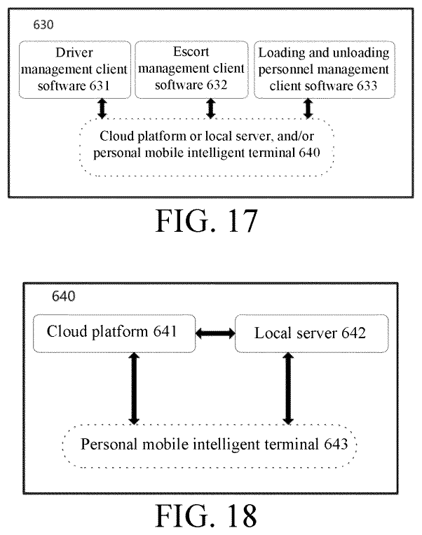

FIG. 17 is a schematic diagram of a constitutional principle of a driver and passenger service client 630 of a remote management unit 600 of a vehicle-mounted hazardous chemicals safety monitoring system provided in this example.

As shown in FIG. 17, the driver and passenger service client 630 of the remote management unit 600 provided in this example includes driver service client software 631, escort service client software 632, and loading and unloading personnel service client software 633 according to different users.

As shown in FIG. 1, FIG. 14, and FIG. 17, the driver service client software 631 of the driver and passenger service management client 630 is configured to receive and display an electronic waybill for road transportation of hazardous goods and the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400 and through the communication center 640, and simultaneously receive and display the emergency rescue guidance information sent by the carrier management client 622 in a manner of text, image, voice, file, or the like, or display the emergency rescue guidance information automatically pushed by the carrier management client 622 after triggering the related early warning and alarm information; and the driver service client software supports performing voice broadcast of warning information, and supports feedback of a risk inspection status and a disposal result to the government industry management client and the carrier management client after the driver completes the risk inspection.

The escort service client software 632 of the driver and passenger service management client 630 is configured to receive and display an electronic waybill for road transportation of hazardous goods and the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400 and through the communication center 640, and simultaneously receive and display the emergency rescue guidance information sent by the carrier management client 622 in a manner of text, image, voice, file, or the like or display the emergency rescue guidance information automatically pushed by the carrier management client 622 after triggering the related early warning and alarm information. The escort service client software supports performing voice broadcast of warning information, and supports the escort in feeding back a risk inspection status and a disposal result to the government industry management client and the carrier management client after the driver completes the risk inspection.

The loading and unloading personnel service client software 633 of the driver and passenger service management client 630 is configured to receive and display an electronic waybill for road transportation of hazardous goods and a quantity change in a loading process and a quantity change in an unloading process and inventory information of hazardous chemical goods uploaded by the hazardous chemical goods automatic inventory module 270 of the anti-theft/robbery monitoring and early warning unit 200, to support querying a type, a quantity, a loading and unloading requirement, a physical characteristic, a chemical characteristic, physical and chemical hazards, and corresponding emergency rescue guidance information of the hazardous chemicals carried at the time.

FIG. 18 is a schematic diagram of composition of a communication center 640 of a remote management unit 600 of a vehicle-mounted hazardous chemicals safety monitoring system provided in this example.

As shown in FIG. 18, the communication center 640 of the remote management unit 600 provided in this example includes a cloud platform 641, a local server 642, and a personal mobile intelligent terminal 643. In this example, an application manner of a communication center in which the cloud platform 641 is in combination with the personal mobile intelligent terminal 643 is preferred, which may be determined according to actual communication conditions of different users. This is not limited herein.

As shown in FIG. 1, FIG. 14, and FIG. 18, the cloud platform 641 of the communication center 640 is configured to upload data information and store alarm information by the vehicle-mounted gateway unit 400, receive data of the government industry management client software 610/the enterprise operation management client software 620/the driver and passenger service client software 630 and invoke a shared data resource pool, support a computer hardware platform environment in which the government industry management client software 610/the enterprise operation management client software 620/the driver and passenger service client software 630 is applied, and support communication exchange between the government industry management client software 610/the enterprise operation management client software 620/the driver and passenger service client software 630 and the vehicle-mounted gateway unit 400. The cloud platform 641 communicates with the vehicle-mounted gateway unit 400, receives and stores the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400, and forwards management instructions or response instructions of the government industry management client software 610, the enterprise operation management client software 620, and the driver and passenger service client software 630 to the vehicle-mounted gateway unit 400. As an example, the cloud platform 641 supports a B/S monitoring client application, and the B/S monitoring client is preferably developed based on a latest version of a high-security operating system and a high-security Xinchuang browser.

The local server 642 of the communication center 640 is configured to upload data information and store alarm information by the vehicle-mounted gateway unit 400, respectively receive data of the government industry management client software 610/the enterprise operation management client software 620/the driver and passenger service client software 630 and invoke a data resource pool, support a computer hardware platform environment in which the government industry management client software 610/the enterprise operation management client software 620/the driver and passenger service client software 630 is applied, and support communication exchange between the government industry management client software 610/the enterprise operation management client software 620/the driver and passenger service client software 630 and the vehicle-mounted gateway unit 400. The local server 642 communicates with the vehicle-mounted gateway unit 400, receives and stores the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400, and forwards management instructions or response instructions of the government industry management client software 610, the enterprise operation management client software 620, and the driver and passenger service client software 630 to the vehicle-mounted gateway unit 400. As an example, the local server 642 supports a C/S monitoring client application, and the C/S monitoring client is developed based on various latest versions of high-security operating systems of a Linux kernel.

The personal handheld intelligent terminal 643 of the communication center 640 is configured to upload data information and store alarm information by the vehicle-mounted gateway unit 400, upload an online query tool and temporary storage space for data information by the government industry management client APP software 610/the enterprise operation management client APP software 620/the driver and passenger service client APP software 630, support a computer hardware platform environment in which the government industry management client APP software 610/the enterprise operation management client APP software 620/the driver and passenger service client APP software 630 is applied, and support communication exchange between the government industry management client APP software 610/the enterprise operation management client APP software 620/the driver and passenger service client APP software 630 and the vehicle-mounted gateway unit 400.

Further, the personal handheld intelligent terminal 643 may further communicate with the vehicle-mounted gateway unit 400 through the cloud platform 641 or the local server 642, receive and store the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit 100 and the vehicle-mounted hazardous chemicals anti-theft/robbery monitoring and early warning unit 200 through the vehicle-mounted gateway unit 400, and forward management instructions or response instructions or emergency rescue guidance information of the government industry management mobile client APP software 610/the enterprise operation management mobile client APP software 620/the driver and passenger service mobile client APP software 630 to the vehicle-mounted gateway unit 400. As an example, the mobile monitoring client APP is preferably developed based on an operating system based on the Linux kernel such as a HarmonyOS microkernel or Android (Android).

When the remote management unit 640 constituted accordingly is deployed, preferably, the remote management unit 640 is set on a cloud platform of a government industry competent department related to vehicle traffic management or operation management and/or a local storage server and/or personal handheld intelligent terminals of related management personnel, and a cloud platform of a transportation enterprise to which a vehicle belongs and a related transportation party and/or a local storage server and/or personal handheld intelligent terminals of related management personnel and personal handheld intelligent terminals of a driver and a passenger, is associated with the vehicle-mounted gateway unit 400, and is indirectly associated with the vehicle-mounted hazardous chemicals physical and chemical safety monitoring and early warning unit 100, the vehicle-mounted hazardous chemicals anti-theft/robbery monitoring and early warning unit 200, the hazardous chemical transportation emergency rescue guidance unit 300, and the alarm prompt unit 500 through the vehicle-mounted gateway unit 400.

The remote management unit 640 thus deployed may receive the vehicle-mounted hazardous chemicals physical and chemical safety monitoring and early warning information or the vehicle-mounted hazardous chemicals anti-theft/robbery monitoring and early warning information that are sent by the vehicle-mounted gateway unit, issues a driver management operation instruction according to the alarm information, feed back the driver management operation instruction to the vehicle-mounted gateway unit, and feed back the driver management operation instruction to the alarm prompt unit through the vehicle-mounted gateway. The remote management unit thus deployed supports, through related monitoring client software, setting and adjustment of an early warning and alarm threshold and an information uploading frequency of related monitoring devices of the vehicle-mounted hazardous chemicals physical and chemical safety monitoring and early warning unit and the vehicle-mounted hazardous chemicals anti-theft/robbery monitoring and early warning unit, and pushes emergency rescue guidance information of hazardous chemical transportation.

When the vehicle-mounted hazardous chemicals safety monitoring system formed based on a specific scheme provided in this example is running, the physical and chemical safety and anti-theft/robbery safety information of vehicle-mounted hazardous chemicals may be automatically monitored. When vehicle-mounted hazardous chemicals are at risk of explosion or being theft/robbed, a sound and light early warning and alarm or a voice prompt is issued to the driver and passenger, to prompt the driver and passenger to get off the vehicle in time for inspection or prepare for defense or perform positioning and tracking, push and issue an on-site voice prompt for emergency disposal or file push guidance, and help the driver and passenger quickly start emergency disposal.

Based on this, this system further cooperates with setting up a remote management unit, so that the physical and chemical safety monitoring information and anti-theft/robbery monitoring information of vehicle-mounted hazardous chemicals may be linked in real time to the competent industry department and affiliated units. While helping the driver and passenger dispose on site and prevent accidents, the system buys time for early deployment of emergency rescue and disposal forces and anti-terrorism prevention forces and quick start of emergency rescue and anti-terrorism investigation work. In this way, it will help improve the monitoring, early warning, and prevention capabilities on hazardous chemical transportation safety accidents of our nation, improve emergency disposal efficiency of hazardous chemical transportation safety accidents, and the anti-terrorism prevention capabilities on hazardous chemical transportation.

Finally, the foregoing method of the present invention that needs to be explained, or a specific system unit, or some units thereof, may be deployed on a physical medium through program code, such as a hard disk, an optical disc, or any electronic apparatus (such as a smart phone, a computer-readable storage medium). When the machine loads and executes the program code (such as a smart phone loads and executes the program code), the machine becomes an apparatus for implementing the present invention. The foregoing method and apparatus of the present invention may also be transmitted in the form of program code through some transmission media, such as a cable, an optical fiber, or any transmission type. When the program code is received, loaded, and executed by a machine (such as a smart phone), the machine becomes an apparatus for implementing the present invention.

The foregoing displays and describes basic principles, main features of the present invention and advantages of the present invention. A person skilled in the art may understand that the present invention is not limited to the foregoing embodiments. Descriptions in the embodiments and this specification only illustrate the principles of the present invention. Various modifications and improvements are made in the present invention without departing from the spirit and the scope of the present invention, and these modifications and improvements shall fall within the protection scope of the present invention. The protection scope of the present invention is defined by the appended claims and equivalents thereof.

What is claimed is:

1. A vehicle-mounted hazardous chemicals safety monitoring system, comprising:
a vehicle-mounted hazardous chemicals physical and chemical safety monitoring and early warning unit, wherein the vehicle-mounted hazardous chemicals physical and chemical safety monitoring and early warning unit is associated with a vehicle-mounted gateway unit, and is associated with an alarm prompt unit and a remote management unit through a vehicle-mounted gateway; and the vehicle-mounted hazardous chemicals physical and chemical safety monitoring and early warning unit is capable of performing real-time monitoring on a physical and chemical safety parameter of vehicle-mounted hazardous chemicals, is capable of directly cooperating with the vehicle-mounted gateway unit according to monitored information to perform early warning analysis on physical and chemical safety of the vehicle-mounted hazardous chemicals, and is capable of generating early warning information when a physical and chemical safety risk occurs on the vehicle-mounted hazardous chemicals, sending the early warning information to the remote management unit through the vehicle-mounted gateway unit, and simultaneously issuing a warning through the alarm prompt unit;
a vehicle-mounted hazardous chemicals anti-theft/robbery monitoring and early warning unit, wherein the vehicle-mounted hazardous chemicals anti-theft/robbery monitoring and early warning unit is associated with the vehicle-mounted gateway unit, and is associated with the alarm prompt unit and the remote management unit through the vehicle-mounted gateway unit; and the vehicle-mounted hazardous chemicals anti-theft/robbery monitoring and early warning unit is capable of performing real-time monitoring on anti-theft/robbery safety information of the vehicle-mounted hazardous chemicals, is capable of directly cooperating with the vehicle-mounted gateway unit according to monitored information to perform early warning analysis on a risk of being theft/robbed or lost on a vehicle carrying hazardous chemicals and the vehicle-mounted hazardous chemicals, and is capable of generating early warning information when the risk occurs, sending the early warning information to the remote management unit through the vehicle-mounted gateway unit, and simultaneously issuing a warning through the alarm prompt unit;
a hazardous chemical transportation emergency rescue guidance unit, wherein the hazardous chemical transportation emergency rescue guidance unit is set to be associated with the vehicle-mounted gateway unit, and is associated with the alarm prompt unit and the remote management unit through the vehicle-mounted gateway unit; and the hazardous chemical transportation emergency rescue guidance unit is capable of being linked with the vehicle-mounted hazardous chemicals physical and chemical safety monitoring and early warning unit and the vehicle-mounted hazardous chemicals anti-theft/robbery monitoring and early warning unit, and is capable of forming emergency disposal on-site guidance information for a vehicle driver when a vehicle triggers a vehicle-mounted hazardous chemicals physical and chemical safety monitoring and early warning and a vehicle-mounted hazardous chemicals anti-theft/robbery monitoring and early warning;
the vehicle-mounted gateway unit, wherein the vehicle-mounted gateway unit is separately associated with the vehicle-mounted hazardous chemicals physical and chemical safety monitoring and early warning unit, the vehicle-mounted hazardous chemicals anti-theft/robbery monitoring and early warning unit, and/or the hazardous chemical transportation emergency rescue guidance unit, the alarm prompt unit, and the remote management unit, and establishes a communication channel between each unit, to complete data exchange; and the vehicle-mounted gateway unit is capable of cooperating with the vehicle-mounted hazardous chemicals physical and chemical safety monitoring and early warning unit and/or the vehicle-mounted hazardous chemicals anti-theft/robbery monitoring and early warning unit to complete risk early warning processing according to data information collected by a corresponding unit;
the alarm prompt unit, wherein the alarm prompt unit is connected to the vehicle-mounted gateway unit, and is capable of completing a local alarm on an automobile and/or completing a remote alarm through the remote management unit associated with the vehicle-mounted gateway unit; and
the remote management unit, wherein the remote management unit is associated with the vehicle-mounted gateway unit, and is indirectly associated with the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit through the vehicle-mounted gateway unit; the remote management unit is capable of forming system configuration information and/or emergency handling information; and is further capable of receiving vehicle-mounted hazardous chemicals physical and chemical safety monitoring information and vehicle-mounted hazardous chemicals anti-theft/robbery monitoring and early warning information that are sent by the vehicle-mounted gateway unit.

2. The vehicle-mounted hazardous chemicals safety monitoring system according to claim 1, wherein the vehicle-mounted hazardous chemicals physical and chemical safety monitoring and early warning unit comprises one or more of a temperature monitoring module, a humidity monitoring module, a pressure monitoring module, a vibration monitoring module, and a leakage monitoring module, monitoring information of various monitoring apparatuses is aggregated to a data storage module of the vehicle-mounted gateway, and early warning analysis is performed through the vehicle-mounted gateway unit, and when a temperature, humidity, pressure, vibration intensity, or a leakage monitoring result is higher than a set threshold, and when risks of combustion, explosion, and leakage of hazardous chemicals occur, a corresponding warning prompt is sent to the alarm prompt unit through the vehicle-mounted gateway unit, and alarm prompt information is simultaneously uploaded to the remote management unit through the vehicle-mounted gateway unit;
the temperature monitoring module is configured to obtain real-time information of temperature of the vehicle-mounted hazardous chemicals, temperature in a compartment, or temperature of a tank, and transmit the obtained information to the vehicle-mounted gateway unit or to the remote management unit through the vehicle-mounted gateway unit;
the humidity monitoring module is configured to obtain real-time information of humidity of the vehicle-mounted hazardous chemicals and humidity in the compartment, and transmit the obtained information to the vehicle-mounted gateway unit or to the remote management unit through the vehicle-mounted gateway unit;
the pressure monitoring module is configured to obtain real-time information of pressure of the vehicle-mounted hazardous chemicals and pressure in the compartment or in the tank, and transmit the obtained information to the vehicle-mounted gateway unit or to the remote management unit through the vehicle-mounted gateway unit;
the vibration monitoring module is configured to obtain real-time information of vibration in the compartment or in the tank in the vehicle carrying the vehicle-mounted hazardous chemicals, and transmit the obtained information to the vehicle-mounted gateway unit or to the remote management unit through the vehicle-mounted gateway unit; and
the leakage monitoring module is configured to obtain real-time information of leakage of the vehicle-mounted hazardous chemicals and leakage of gas in the compartment in the vehicle carrying the vehicle-mounted hazardous chemicals or leakage of liquid or gas at an outlet of the tank, and transmit the obtained information to the vehicle-mounted gateway unit or to the remote management unit through the vehicle-mounted gateway unit.

3. The vehicle-mounted hazardous chemicals safety monitoring system according to claim 1, wherein the vehicle-mounted hazardous chemicals anti-theft/robbery monitoring and early warning unit comprises one or more of a vehicle anti-theft alarm module, a vehicle anti-robbery monitoring module, a vehicle anti-theft/robbery positioning and tracking module, a vehicle fuel tank security monitoring module, an access control intrusion detection module, a goods anti-theft video monitoring module, and/or a hazardous chemical goods automatic inventory module, monitoring data of various modules is aggregated to the vehicle-mounted gateway unit, and anti-theft/robbery risk early warning analysis is performed through the vehicle-mounted gateway unit, and when a corresponding anti-theft/robbery warning is triggered, a corresponding warning is sent to the alarm prompt unit through the vehicle-mounted gateway unit, and alarm prompt information is simultaneously uploaded to the remote management unit through the vehicle-mounted gateway unit;
the vehicle anti-theft alarm module comprises a direct contact sensor and/or a current and voltage drop sensor and/or an ultrasonic sensor and/or a microwave sensor and/or a shock sensor and/or an inclination sensor, and is configured to monitor an illegal position movement or abnormal startup of a vehicle in a parking state, and transmit monitoring information to a data storage module and an edge computing module of the vehicle-mounted gateway unit or to the remote management unit through a network communication module of the vehicle-mounted gateway unit;
the vehicle anti-robbery module comprises one or more of a video monitoring device outside a vehicle, a concealed alarm button, a wireless emission pinhole video camera, a warning light, a tear gas sprayer outside a vehicle body, and another self-defense equipment, and is configured to monitor armed persons and an abnormal gathering of persons around the vehicle, and transmit monitoring information to the vehicle-mounted gateway unit or to the remote management unit through the vehicle-mounted gateway unit;
the vehicle anti-theft/robbery positioning and tracking module comprises one or more of a deep dormancy tracking locator, a solar charger, and a pinhole infrared camera at a driver's position of a vehicle, and is configured to perform positioning and tracking on a real-time position of the vehicle after an anti-theft/robbery alarm is triggered, and transmit tracked positioning information to the remote management unit through the vehicle-mounted gateway unit;
the vehicle fuel tank security monitoring module comprises one or more of an infrared detector disposed on a fuel tank cap, a vibration sensor, a liquid level sensor disposed in a fuel tank and/or a pinhole infrared camera that is capable of monitoring a position of a fuel tank in real time, and is configured to perform real-time video monitoring on a position of a fuel tank of a truck carrying hazardous chemicals, and transmit monitoring information to the vehicle-mounted gateway unit or directly to the remote management unit through the vehicle-mounted gateway unit;
the access control intrusion detection module comprises one or more of an access controller disposed on a compartment door of a truck carrying hazardous chemical goods or an inlet/outlet pipeline/an oil discharge valve of an oil pump of a tanker, a passive infrared intrusion detector and/or an active infrared intrusion detector and/or a microwave intrusion detector and/or a radar microwave detector and/or a switchable detector and/or an ultrasonic detector and/or a sound-activated detector and/or a wireless magnetic switch detector, a vibration sensor, and a pinhole camera that is capable of monitoring a position of a compartment door of a truck or an inlet/outlet pipeline/an oil discharge valve of an oil pump of a tanker in real time, and is configured to monitor a compartment door body of a truck carrying explosive hazardous chemical goods or an inlet/outlet pipeline/an oil discharge valve of an oil pump of a tanker, and transmit monitoring information to the vehicle-mounted gateway unit or directly to the remote management unit through the vehicle-mounted gateway unit;
the goods anti-theft video monitoring module comprises goods image monitoring cameras disposed above four corners of a compartment and a process monitoring camera that directly faces a compartment door and that is disposed in the compartment, and is configured to perform video monitoring on goods inside a closed van truck carrying hazardous chemicals and all openings of the tanker, and transmit monitoring information to the vehicle-mounted gateway unit or directly to the remote management unit through the vehicle-mounted gateway unit; and
the hazardous chemical goods automatic inventory module comprises a code scanner or a radio frequency identification card reader disposed at the compartment door, and a barcode label, a two-dimensional code label, or a radio frequency identification electronic label disposed on packaging of hazardous chemical goods, and is configured to perform real-time registration on a quantity change in a loading process and a quantity change in an unloading process of the hazardous chemical goods, perform regular or irregular quantity inventory on the carried explosive hazardous chemical goods, and transmit registration and inventory information to the vehicle-mounted gateway unit or directly to the remote management unit through the vehicle-mounted gateway unit.

4. The vehicle-mounted hazardous chemicals safety monitoring system according to claim 1, wherein the hazardous chemical transportation emergency rescue guidance unit comprises an emergency rescue guidance information module, a voice broadcast module, and an automatic push module, wherein
the emergency rescue guidance information module is configured to provide emergency rescue guidance information of hazardous chemicals;
the voice broadcast module is configured to perform voice broadcast on emergency rescue guidance information in real time when an early warning and an alarm occur, to guide a driver and a passenger to perform preliminary emergency disposal; and
the automatic push module is configured to push an emergency rescue guidance information file in real time when the early warning and the alarm occur, to guide the driver and the passenger to perform preliminary emergency disposal.

5. The vehicle-mounted hazardous chemicals safety monitoring system according to claim 1, wherein the vehicle-mounted gateway unit comprises a network communication module and/or a data storage module and/or an edge computing module, wherein
the network communication module comprises one or more of a 5G communication apparatus, a CAN bus communication apparatus, a TCP/IP communication apparatus, a Bluetooth communication apparatus, and another wireless communication apparatus, and is configured to perform data exchange between the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit and the remote management unit;
the data storage module comprises a built-in data storage apparatus and an external data storage apparatus, and is configured to store monitoring information uploaded by the vehicle-mounted hazardous chemicals physical and chemical safety monitoring and early warning unit and the vehicle-mounted hazardous chemicals anti-theft/robbery monitoring and early warning unit and an emergency rescue guidance information file of the hazardous chemical transportation emergency rescue guidance unit; and
the edge computing module comprises an AI smart chip having an edge computing function and a terminal SDK having the edge computing function, and is configured to perform intelligent analysis and determining on the monitoring information uploaded by the vehicle-mounted hazardous chemicals physical and chemical safety monitoring and early warning unit and the vehicle-mounted hazardous chemicals anti-theft/robbery monitoring and early warning unit.

6. The vehicle-mounted hazardous chemicals safety monitoring system according to claim 1, wherein the vehicle-mounted gateway unit is directly associated with the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, the alarm prompt unit, and the remote management unit;
when the vehicle-mounted gateway unit receives the monitoring information from the vehicle-mounted hazardous chemicals physical and chemical safety monitoring and early warning unit and the vehicle-mounted hazardous chemicals anti-theft/robbery monitoring and early warning unit, and analyzes and determines that hazardous chemicals explosion or theft/robbery-related early warning and alarm is triggered, a sound and light alarm or voice prompt information is sent to the alarm prompt unit through the vehicle-mounted gateway unit and early warning and alarm information and real-time monitoring information are sent to the remote management unit; and
when receiving an alarm instruction, a voice prompt instruction, alarm threshold setting adjustment or emergency rescue guidance information sent by the remote management unit, the vehicle-mounted gateway unit sends the alarm instruction and the voice prompt instruction information to the alarm prompt unit, sends the alarm threshold setting adjustment and circuit control instruction information to related monitoring apparatuses of the vehicle-mounted hazardous chemicals physical and chemical safety monitoring and early warning unit and the vehicle-mounted hazardous chemicals anti-theft/robbery monitoring and early warning unit to adjust an alarm threshold of a monitoring sensor and start a positioning and tracking apparatus or a related operation of a related pinhole camera, and sends emergency rescue guidance voice broadcast information to a voice broadcast module of the hazardous chemical transportation emergency rescue guidance unit to guide the driver and the passenger to perform preliminary emergency disposal.

7. The vehicle-mounted hazardous chemicals safety monitoring system according to claim 1, wherein the alarm prompt unit comprises a vehicle local alarm prompt subunit and a remote monitoring client software alarm prompt subunit.

8. The vehicle-mounted hazardous chemicals safety monitoring system according to claim 1, wherein
the remote management unit comprises government industry management client software, enterprise operation management client software, driver and passenger service client software, and a communication center, wherein
the government industry management client software is configured to receive and display vehicle-mounted hazardous chemicals physical and chemical safety monitoring and early warning information or vehicle-mounted hazardous chemicals anti-theft/robbery monitoring and early warning information of a high risk level forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, issue a related management instruction according to the received early warning and alarm information, start an emergency management procedure, and issue a related emergency disposal instruction;
the enterprise operation management client software is configured to receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, and issue the related management instruction or emergency rescue guidance information according to the received early warning and alarm information; when receiving the vehicle-mounted hazardous chemicals physical and chemical safety monitoring and early warning information or the vehicle-mounted hazardous chemicals anti-theft/robbery monitoring and early warning information of a high risk level, start the emergency management procedure, push vehicle-mounted hazardous chemical emergency rescue guidance file information to a vehicle-mounted hazardous chemicals emergency rescue guidance module, send an emergency alarm to a government industry management client, and issue the related emergency disposal instruction;
the driver and passenger service client software is configured to receive and display the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit and the communication center, issue a sound and light alarm, a voice prompt, and emergency rescue guidance corresponding to alarm and early warning information according to the received alarm and early warning information, prompt a driver to stop nearby or immediately stop for inspection, and provide a corresponding emergency disposal guidance scheme; and
the communication center is configured to communicate with the vehicle-mounted gateway unit, receive and store the vehicle-mounted hazardous chemicals physical and chemical safety monitoring and early warning information or the vehicle-mounted hazardous chemicals anti-theft/robbery monitoring and early warning information forwarded by the vehicle-mounted hazardous chemicals physical and chemical safety monitoring and early warning unit and the vehicle-mounted hazardous chemicals anti-theft/robbery monitoring and early warning unit through the vehicle-mounted gateway unit, and separately forward to the government industry management client software, the enterprise operation management client software, and the driver and passenger service client software.

9. The vehicle-mounted hazardous chemicals safety monitoring system according to claim 8, wherein the remote management unit comprises a government industry management client, an enterprise operation management client, a driver and passenger service client, and a communication center, wherein
the government industry management client of the remote management unit comprises public security industry management client software, traffic industry management client software, emergency industry management client software, and another industry management client software according to different competent industry departments;
the enterprise operation management client of the remote management unit comprises consignor management client software, carrier management client software, and consignee management client software according to different users;
the driver and passenger service management client of the remote management unit comprises driver service client software, escort service client software, and loading and unloading personnel service client software according to different users; and
the communication center of the remote management unit comprises a cloud platform, a local server, and a personal mobile intelligent terminal.

10. The vehicle-mounted hazardous chemicals safety monitoring system according to claim 1, wherein the remote management unit is set on a cloud platform of a government industry competent department related to vehicle traffic management or operation management and/or a local storage server and/or personal handheld intelligent terminals of related management personnel, and a cloud platform of a transportation enterprise to which a vehicle belongs and a related transportation party and/or a local storage server and/or personal handheld intelligent terminals of related management personnel and personal handheld intelligent terminals of a driver and a passenger, is associated with the vehicle-mounted gateway unit, and is indirectly associated with the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, and the alarm prompt unit through the vehicle-mounted gateway unit.

11. The vehicle-mounted hazardous chemicals safety monitoring system according to claim 5, wherein the vehicle-mounted gateway unit is directly associated with the vehicle-mounted hazardous chemicals physical and chemical safety monitoring and early warning unit, the vehicle-mounted hazardous chemicals anti-theft/robbery monitoring and early warning unit, the hazardous chemical transportation emergency rescue guidance unit, the alarm prompt unit, and the remote management unit;
when the vehicle-mounted gateway unit receives the monitoring information from the vehicle-mounted hazardous chemicals physical and chemical safety monitoring and early warning unit and the vehicle-mounted hazardous chemicals anti-theft/robbery monitoring and early warning unit, and analyzes and determines that hazardous chemicals explosion or theft/robbery-related early warning and alarm is triggered, a sound and light alarm or voice prompt information is sent to the alarm prompt unit through the vehicle-mounted gateway unit and early warning and alarm information and real-time monitoring information are sent to the remote management unit; and
when receiving an alarm instruction, a voice prompt instruction, alarm threshold setting adjustment or emergency rescue guidance information sent by the remote management unit, the vehicle-mounted gateway unit sends the alarm instruction and the voice prompt instruction information to the alarm prompt unit, sends the alarm threshold setting adjustment and circuit control instruction information to related monitoring apparatuses of the vehicle-mounted hazardous chemicals physical and chemical safety monitoring and early warning unit and the vehicle-mounted hazardous chemicals anti-theft/robbery monitoring and early warning unit to adjust an alarm threshold of a monitoring sensor and start a positioning and tracking apparatus or a related operation of a related pinhole camera, and sends emergency rescue guidance voice broadcast information to a voice broadcast module of the hazardous chemical transportation emergency rescue guidance unit to guide the driver and the passenger to perform preliminary emergency disposal.
